(19) United States
(12) Patent Application Publication
(10) Pub. No.: US 2010/0232685 A1
(43) Pub. Date: Sep. 16, 2010

(54) IMAGE PROCESSING APPARATUS AND METHOD, LEARNING APPARATUS AND METHOD, AND PROGRAM

(76) Inventors: Masatoshi YOKOKAWA, Kanagawa (JP); Kazuki Aisaka, Kanagawa (JP); Jun Murayama, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/708,594

(22) Filed: Feb. 19, 2010

(30) Foreign Application Priority Data
Mar. 13, 2009 (JP) P2009-060620

(51) Int. Cl. G06K 9/62; G06K 9/48

(52) U.S. Cl. 382/159; 382/199; 382/224

(57) ABSTRACT

An image processing apparatus includes: an edge intensity detecting unit configured to detect the edge intensity of an image in increments of blocks having a predetermined size; a parameter setting unit configured to set an edge reference value used for extraction of an edge point that is a pixel used for detection of the blurred degree of the image based on a dynamic range that is difference between the maximum value and the minimum value of the edge intensities; and an edge point extracting unit configured to extract a pixel as the edge point with the edge intensity being equal to or greater than the edge reference value, and also the pixel value of a pixel within a block being included in an edge block that is a block within a predetermined range.

### BACKGROUND OF THE INVENTION

1. Field of the Invention

The present invention relates to an image processing apparatus and method, a learning apparatus and method, and a program, and specifically, relates to an image processing apparatus and method, a learning apparatus and method, and a program, which are suitably used for detection of a blurred degree of an image.

2. Description of the Related Art

Heretofore, a technique has been proposed wherein a pixel making up an edge within an image (hereafter, referred to as “edge point”) is extracted using wavelet transform, and the type of the extracted edge point is analyzed, thereby detecting a blurred degree that is an index indicating the blurred degree of an image (e.g., Hanghang Tong, Mingiing Li, Hongiiang Zhang, Changshui Zhang, “Blur Detection for Digital Images Using Wavelet Transform”, Multimedia and Expo. 2004, ICME '04, 2004 IEEE International Conference on 27-30 Jun. 2004, page(s) 17-20).

### SUMMARY OF THE INVENTION

Now, the amount of an edge included in an image greatly varies depending on the type of subject such as scenery, a person's face, or the like. For example, in the case of an image such as an artificial pattern, a building, or the like, which include a great amount of texture, the edge amount is great, and in the case of an image such as natural scenery, a person's face, or the like, which does not include so much texture, the edge amount is small.

However, with the invention disclosed in Hanghang Tong, Mingiing Li, Hongiiang Zhang, Changshui Zhang, “Blur Detection for Digital Images Using Wavelet Transform”, Multimedia and Expo. 2004, ICME '04, 2004 IEEE International Conference on 27-30 Jun. 2004, page(s) 17-20, an edge point is extracted using constant parameters all the time, and a blurred degree is detected by analyzing the extracted edge point, and accordingly, the detection precision of a blurred degree varies depending on the edge amount included in an image. For example, with regard to an image not including so much texture of which the edge amount is small, an insufficient amount of edge points are extracted, and consequently, the detection precision of a blurred degree tends to deteriorate.

It has been found to be desirable to enable the blurred degree of an image to be detected with higher precision.

According to an embodiment of the present invention, an image processing apparatus includes: an edge intensity detecting unit configured to detect the edge intensity of an image in increments of blocks having a predetermined size; a parameter setting unit configured to set an edge reference value used for extraction of an edge point that is a pixel used for detection of the blurred degree of the image based on a dynamic range that is difference between the maximum value and the minimum value of the edge intensities; and an edge point extracting unit configured to extract a pixel as the edge point with the edge intensity being equal to or greater than the edge reference value, and also the pixel value of a pixel within a block being included in an edge block that is a block within a predetermined range.

The edge intensity detecting unit may detect the edge intensity of the image in increments of first blocks having a first size, and further detect the edge intensity of the image in increments of second blocks having a second size different from the first size by detecting the edge intensity of a first averaged image made up of the average value of pixels within each block obtained by dividing the image into blocks having the first size in increments of blocks having the first size, and further detect the edge intensity of the image in increments of third blocks having a third size different from the first size and the second size by detecting the edge intensity of a second averaged image made up of the average value of pixels within each block obtained by dividing the first averaged image into blocks having the first size in increments of blocks having the first size, and the edge point extracting unit may extract a pixel as the edge point with the edge intensity being included in one of the first through third blocks of which the edge intensity is equal to or greater than the edge reference value, and also the pixel value of the first averaged image being included in a block within a predetermined range.

The parameter setting unit may further set an extracted reference value used for determination regarding whether or not the extracted amount of the edge point is suitable based on the dynamic range of the image, and also adjust the edge reference value so that the extracted amount of the edge point becomes suitable amount as compared to the extracted reference value.

The image processing apparatus may further include: an analyzing unit configured to analyze whether or not blur occurs at the extracted edge point; and a blurred degree detecting unit configured to detect the blurred degree of the image based on analysis results by the analyzing unit.

The edge point extracting unit may classify the type of the image based on predetermined classifying parameters, and set the edge reference value based on of the dynamic range and type of the image.

The classifying parameters may include at least one of the size of the image and the shot scene of the image.

The edge intensity detecting unit may detect the intensity of an edge of the image based on a difference value of the pixel values of pixels within a block.

According to an embodiment of the present invention, an image processing method for an image processing apparatus configured to detect the blurred degree of an image, includes the steps of: detecting the edge intensity of the image in increments of blocks having a predetermined size; setting an edge reference value used for extraction of an edge point that is a pixel used for detection of the blurred degree of the image based on a dynamic range that is difference between the maximum value and the minimum value of the edge intensities and extracting a pixel as the edge point with the edge intensity being equal to or greater than the edge reference value, and also the pixel value of a pixel within a block being included in an edge block that is a block within a predetermined range.

According to an embodiment of the present invention, a program causing a computer to execute processing includes the steps of: detecting the edge intensity of the image in increments of blocks having a predetermined size; setting an edge reference value used for extraction of an edge point that is a pixel used for detection of the blurred degree of the image based on a dynamic range that is difference between the maximum value and the minimum value of the edge intensities; and extracting a pixel as the edge point with the edge intensity being equal to or greater than the edge reference value, and also the pixel value of a pixel within a block being included in an edge block that is a block within a predetermined range.

With the above configuration, the edge intensity of an image is detected in increments of blocks having a predetermined size, an edge reference value used for extraction of an edge point that is a pixel used for detection of the blurred degree of the image is set based on a dynamic range that is difference between the maximum value and the minimum value of the edge intensity, and a pixel is extracted as the edge point with the edge intensity being equal to or greater than the edge reference value, and also the pixel value of a pixel within a block being included in an edge block that is a block within a predetermined range.

According to the above configuration, an edge point used for detection of the blurred degree of an image can be extracted. In particular, according to the above embodiment, an edge point can be extracted suitably, and consequently, the blurred degree of an image can be detected with higher precision.

According to an embodiment of the present invention, a learning apparatus includes: an image processing unit configured to detect the edge intensity of an image in increments of blocks having a predetermined size, classify the type of the image based on a dynamic range that is difference between the maximum value and the minimum value of the edge intensities, extract a pixel included in an edge block that is a block of which the edge intensity is equal to or greater than an edge reference value that is a first threshold as an edge point, and in the case that the extracted amount of the edge point is equal to or greater than an extracted reference value that is a second threshold, analyze whether or not blur occurs at the edge point to determine whether or not the image blurs; and a parameter extracting unit configured to extract a combination of the edge reference value and the extracted reference value; with the image processing unit using each of a plurality of combinations of the edge reference value and the extracted reference value to classify, regarding a plurality of tutor images, the types of the tutor images, and also determining whether or not the tutor images blur; and with the parameter extracting unit extracting a combination of the edge reference value and the extracted reference value for each type of the image at which the determination precision regarding whether or not the tutor images from the image processing unit blur becomes the highest.

The image processing unit may use each of a plurality of combinations of dynamic range determining values for classifying the type of the image based on the edge reference value, the extracted reference value, and the dynamic range of the image to classify, regarding a plurality of tutor images, the types of the tutor images based on the dynamic range determining values, and also determine whether or not the tutor images blur; with the parameter extracting unit extracting a combination of the edge reference value, the extracted reference value, and the dynamic range determining value for each type of the image at which the determination precision regarding whether or not the tutor images from the image processing unit blur becomes the highest.

According to an embodiment of the present invention, a learning method for a learning apparatus configured to learn a parameter used for detection of the blurred degree of an image, includes the steps of: using each of a plurality of combinations of an edge reference value that is a first threshold, and an extracted reference value that is a second threshold to detect, regarding a plurality of tutor images, the edge intensities of the tutor images in increments of blocks having a predetermined size, classifying the types of the tutor images based on a dynamic range that is difference between the maximum value and the minimum value of the edge intensities, extracting a pixel included in an edge block that is a block of which the edge intensity is equal to or greater than the edge reference value as an edge point, and in the case that the extracted amount of the edge point is equal to or greater than the extracted reference value, analyzing whether or not blur occurs at the edge point to determine whether or not the tutor images blur; and extracting a combination of the edge reference value and the extracted reference value for each type of the image at which determination precision regarding whether or not the tutor images blur becomes the highest.

According to an embodiment of the present invention, a program causes a computer to execute processing including the steps of: using each of a plurality of combinations of an edge reference value that is a first threshold, and an extracted reference value that is a second threshold to detect, regarding a plurality of tutor images, the edge intensities of the tutor images in increments of blocks having a predetermined size, classifying the types of the tutor images based on a dynamic range that is difference between the maximum value and the minimum value of the edge intensities, extracting a pixel included in an edge block that is a block of which the edge intensity is equal to or greater than the edge reference value as an edge point, and in the case that the extracted amount of the edge point is equal to or greater than the extracted reference value, analyzing whether or not blur occurs at the edge point to determine whether or not the tutor images blur; and extracting a combination of the edge reference value and the extracted reference value for each type of the image at which determination precision regarding whether or not the tutor images blur becomes the highest.

With the above configuration, each of a plurality of combinations of an edge reference value that is a first threshold, and an extracted reference value that is a second threshold is used to detect, regarding a plurality of tutor images, the edge intensities of the tutor images in increments of blocks having a predetermined size, the types of the tutor images are classified based on a dynamic range that is difference between the maximum value and the minimum value of the edge intensities, a pixel included in an edge block that is a block of which the edge intensity is equal to or greater than the edge reference value is extracted as an edge point, and in the case that the extracted amount of the edge point is equal to or greater than the extracted reference value, analysis is made whether or not blur occurs at the edge point to determine whether or not the tutor images blur; and a combination of the edge reference value and the extracted reference value is extracted for each type of the image at which determination precision regarding whether or not the tutor images blur becomes the highest.

According to the above configurations, a combination of an edge reference value and an extracted reference value used for detection of the blurred degree of an image can be extracted. In particular, according to the above embodiment, a combination of the edge reference value and the extracted reference value can be extracted suitably, and consequently, the blurred degree of an image can be detected with higher precision.

### BRIEF DESCRIPTION OF THE DRAWINGS

FIG. 1 is a block diagram illustrating a first embodiment of an image processing apparatus to which the present invention has been applied;

FIG. 2 is a flowchart for describing blur degree detecting processing to be executed by the image processing apparatus according to the first embodiment of the present invention;

FIG. 3 is a diagram for describing creating processing of edge maps;

FIG. 4 is a diagram for describing creating processing of local maximums;

FIG. 5 is a diagram illustrating an example of the configuration of an edge;

FIG. 6 is a diagram illustrating another example of the configuration of an edge;

FIG. 7 is a diagram illustrating yet another example of the configuration of an edge;

FIG. 8 is a diagram illustrating yet another example of the configuration of an edge;

FIG. 9 is a block diagram illustrating a second embodiment of an image processing apparatus to which the present invention has been applied;

FIG. 10 is a flowchart for describing blur degree detecting processing to be executed by the image processing apparatus according to the second embodiment of the present invention;

FIG. 11 is a block diagram illustrating a third embodiment of an image processing apparatus to which the present invention has been applied;

FIG. 12 is a flowchart for describing blur degree detecting processing to be executed by the image processing apparatus according to the third embodiment of the present invention;

FIG. 13 is a diagram for describing an example wherein the detection precision of a blurred degree deteriorates due to over exposure of an image;

FIG. 14 is a diagram for describing an example wherein the detection precision of a blurred degree deteriorates due to over exposure of an image;

FIG. 15 is a diagram for describing an example wherein the detection precision of a blurred degree deteriorates due to over exposure of an image;

FIG. 16 is a diagram for describing an example wherein the detection precision of a blurred degree deteriorates due to over exposure of an image;

FIG. 17 is a diagram for describing an example wherein the detection precision of a blurred degree deteriorates due to over exposure of an image;

FIG. 18 is a diagram for describing an example wherein the detection precision of a blurred degree deteriorates due to over exposure of an image;

FIG. 19 is a block diagram illustrating a fourth embodiment of an image processing apparatus to which the present invention has been applied;

FIG. 20 is a flowchart for describing blur degree detecting processing to be executed by the image processing apparatus according to the fourth embodiment of the present invention;

FIG. 21 is a diagram for describing the setting method of FLAG;

FIG. 22 is a block diagram illustrating an embodiment of a learning apparatus to which the present invention has been applied;

FIG. 23 is a diagram illustrating an example of a combination of parameters used for learning processing;

FIG. 24 is a flowchart for describing the learning processing to be executed by the learning apparatus;

FIG. 25 is a flowchart for describing the learning processing to be executed by the learning apparatus;

FIG. 26 is a flowchart for describing the learning processing to be executed by the learning apparatus;

FIG. 27 is a diagram illustrating an example of a ROC curve of highSharp and highBlur obtained as to each combination of an edge reference value and an extracted reference value; and

FIG. 28 is a diagram illustrating a configuration example of a computer.

### DESCRIPTION OF THE PREFERRED EMBODIMENTS

The best modes for carrying out the present invention (hereafter, referred to as embodiments) will be described below. Note that description will be made in accordance with the following sequence.

1. First Embodiment (Example for classifying an image according to a dynamic range to detect a blurred degree)

2. Modification of First Embodiment

3. Second Embodiment (Example for classifying an image according to a dynamic range and the size of the image to detect a blurred degree)

4. Modification of Second Embodiment

5. Third Embodiment (Example for classifying an image according to a dynamic range and a location of shooting to detect a blurred degree)

6. Modification of Third Embodiment

7. Fourth Embodiment (Example for subjecting to over exposure countermeasures to detect a blurred degree)

8. Modification of Fourth Embodiment

9. Fifth Embodiment (Learning processing of parameters used for detection of a blurred degree)

10. Modification of Fifth Embodiment

### 1. First Embodiment

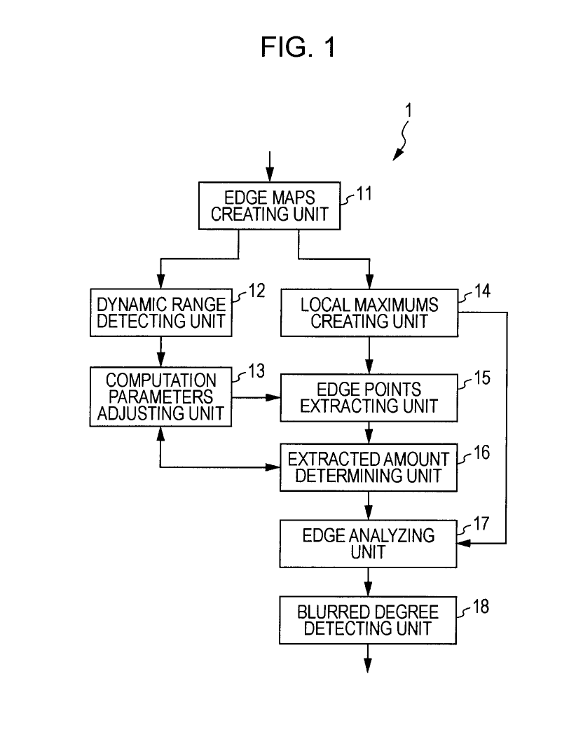

First, description will be made regarding a first embodiment of an image processing apparatus to which the present invention has been applied, with reference to FIGS. 1 through 8.

### Functional Configuration Example of Image Processing Apparatus

FIG. 1 is a block diagram illustrating a configuration example of the function of an image processing apparatus 1 serving as the first embodiment of the image processing apparatus to which the present invention has been applied.

The image processing apparatus 1 analyzes whether or not blur occurs at an edge point within an image that has been input (hereafter, referred to as “input image”), and detect a blurred degree of the input image based on the analysis results. The image processing apparatus 1 is configured so as to include an edge maps creating unit 11, a dynamic range detecting unit 12, a computation parameters adjusting unit 13, a local maximums creating unit 14, an edge points extracting unit 15, an extracted amount determining unit 16, an edge analyzing unit 17, and a blurred degree detecting unit 18.

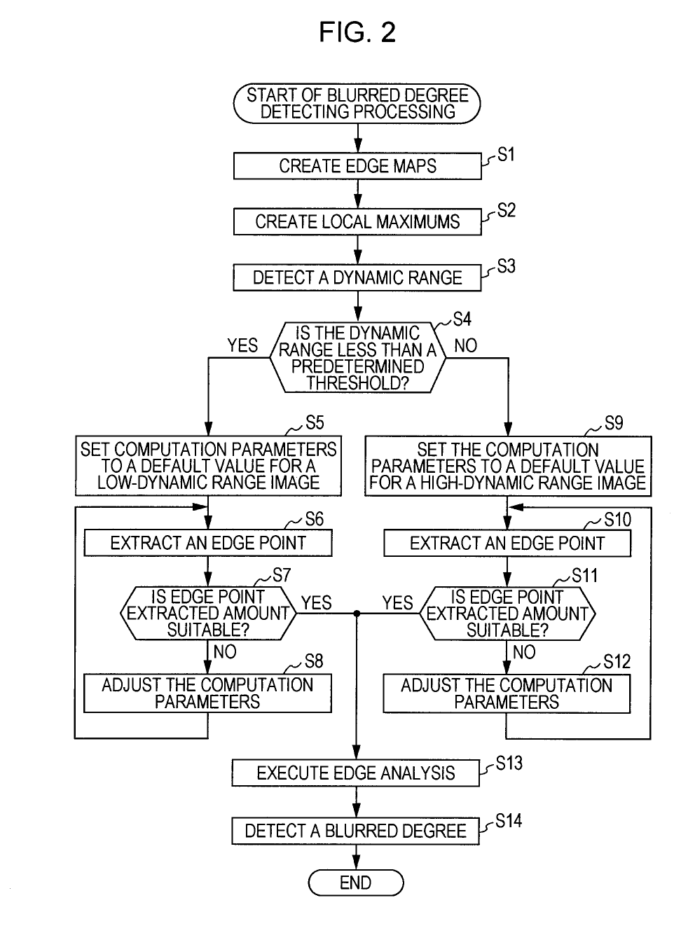

The edge maps creating unit 11 detects, such as described later with reference to FIG. 2, the intensity of an edge (hereafter, referred to as “edge intensity”) of the input image in increments of three types of blocks of which the sizes of scales 1 through 3 differ, and creates the edge maps of the scales 1 through 3 (hereafter, referred to as “edge maps 1 through 3”) with the detected edge intensity as an pixel value. The edge maps creating unit 11 supplies the created edge maps 1 through 3 to the dynamic range detecting unit 12 and the local maximums creating unit 14.

The dynamic range detecting unit 12 detects, such as described later with reference to FIG. 2, a dynamic range that is difference between the maximum value and the minimum value of the edge intensities of the input image, and supplies information indicating the detected dynamic range to the computation parameters adjusting unit 13.

The computation parameters adjusting unit 13 adjusts, such as described later with reference to FIG. 2, computation parameters to be used for extraction of an edge point based on the detected dynamic range so that the extracted amount of an edge point (hereafter, also referred to as “edge point extracted amount”) to be used for detection of a blurred degree of the input image becomes a suitable value. The computation parameters include an edge reference value to be used for determination regarding whether or not the detected point is an edge point, and an extracted reference value to be used for determination regarding whether or not the edge point extracted amount is suitable. The computation parameters adjusting unit 13 supplies information indicating the edge reference value that has been set, to the edge points extracting unit 15 and the extracted amount determining unit 16, and supplies information indicating the extracted reference value that has been set, to the extracted amount determining unit 16.

The local maximums creating unit 14 divides, such as described later with reference to FIG. 2, each of the edge maps 1 through 3 into blocks having a predetermined size, and extracts the maximum value of the pixel values of each block, thereby creating local maximums of scales 1 through 3 (hereafter, referred to as “local maximums 1 through 3”). The local maximums creating unit 14 supplies the created local maximums 1 through 3 to the edge points extracting unit 15 and the edge analyzing unit 17.

The edge points extracting unit 15 extracts, such as described later with reference to FIG. 2, an edge point from the input image based on the edge reference value and the local maximums 1 through 3, creates edge point tables of the scales 1 through 3 (hereafter, referred to as “edge point tables 1 through 3”) indicating the information of the extracted edge point, and supplies these to the extracted amount determining unit 16.

The extracted amount determining unit 16 determines, such as described later with reference to FIG. 2, whether or not the edge point extracted amount is suitable based on the edge point tables 1 through 3 and the extracted reference value. In the case of determining that the edge point extracted amount is not suitable, the extracted amount determining unit 16 notifies the computation parameters adjusting unit 13 that the edge point extracted amount is not suitable, and in the case of determining that the edge point extracted amount is suitable, supplies the edge reference value and edge point tables 1 through 3 at that time to the edge analyzing unit 17.

The edge analyzing unit 17 analyzes, such as described later with reference to FIG. 2, the extracted edge point, and supplies information indicating the analysis results to the blurred degree detecting unit 18.

The blurred degree detecting unit 18 detects, such as described later with reference to FIG. 2, a blurred degree that is an index indicating the blurred degree of the input image based on the analysis results of the edge point. The blurred degree detecting unit 18 outputs information indicating the detected blurred degree externally.

Note that description will be made below regarding an example in the case that the range of a pixel value of the input image is 0 (black, the darkest) through 255 (white, the brightest).

### Description of Operation

Next, blurred degree detecting processing to be executed by the image processing apparatus 1 will be described with reference to the flowchart in FIG. 2. Note that this processing is started, for example, when an input image serving as a detected target is input to the edge maps creating unit 11.

In step S1, the edge maps creating unit 11 creates edge maps. Specifically, the edge maps creating unit 11 divides the input image into blocks having a size of 2×2 pixels, and calculates absolute values M_{TL}_{_{—}}_{TR} through M_{BL}_{_{—}}_{BR} of difference between pixels within each block based on the following Expressions (1) through (6).

M_{TL}_{_{—}}_{TR}=|a−b| (1)

M_{TL}_{_{—}}_{BL}=|a−c| (2)

M_{TL}_{_{—}}_{BR}=|a−d| (3)

M_{TL}_{_{—}}_{BL}=|b−c| (4)

M_{TL}_{_{—}}_{BR}=|b−d| (5)

M_{BL}_{_{—}}_{BR}=|c−d| (6)

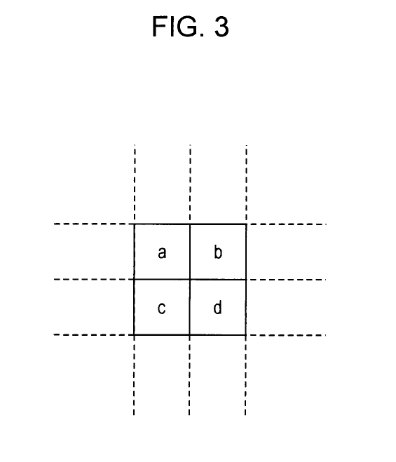

Note that, in Expressions (1) through (6), such as shown in FIG. 3, the pixel value a indicates the pixel value of an upper left pixel within the block, the pixel value b indicates the pixel value of an upper right pixel within the block, the pixel value c indicates the pixel value of a lower left pixel within the block, and the pixel value d indicates the pixel value of a lower right pixel within the block.

Next, the edge maps creating unit 11 calculates the mean M_{Ave} of the difference absolute values M_{TL}_{_{—}}_{TR} through M_{BL}_{_{—}}_{BR} based on the following Expression (7).

$${M}_{Ave} = \frac{\begin{matrix}{M}_{TL\_TR} + {M}_{TL\_BL} + {M}_{TL\_BR} + \\ {M}_{TR\_BL} + {M}_{TR\_BR} + {M}_{BL\_BR}\end{matrix}}{6} \qquad ( 7 )$$

That is to say, the mean M_{Ave} represents the mean of edge intensities in the vertical, horizontal, and oblique direction within the block.

The edge maps creating unit 11 arrays the calculated mean value M_{Ave} in the same order as the corresponding block, thereby creating an edge map 1.

Further, in order to create edge maps 2 and 3, the edge maps creating unit 11 creates the averaged images of the scales 2 and 3 based on the following Expression (8).

$${P}_{( m , n )}^{i + 1} = \frac{{P}_{( 2 m , 2 n )}^{i} + {P}_{( 2 m , 2 n + 1 )}^{i} + {P}_{( 2 m + 1 , 2 n )}^{i} + {P}_{( 2 m + 1 , 2 n + 1 )}^{i}}{4} \qquad ( 8 )$$

Note that, in Expression (8), Pⁱ(x, y) represents the pixel value of coordinates (x, y) of the averaged image of scale i, and Pⁱ⁺¹ (x, y) represents the pixel value of coordinates (x, y) of the averaged image of scale i+1. Now, let us say that the averaged image of the scale 1 is an input image. That is to say, the averaged image of the scale 2 is an image made up of the mean of pixel values of each block obtained by dividing the input image into blocks having a size of 2×2 pixels, and the averaged image of the scale 3 is an image made up of the mean of pixel values of each block obtained by dividing the averaged image of the scale 2 into blocks having a size of 2×2 pixels.

The edge maps creating unit 11 subjects each of the averaged images of the scales 2 and 3 to the same processing as the processing as to the input image using Expressions (1) through (7) to create edge maps 2 and 3.

Accordingly, the edge maps 1 through 3 are images obtained by extracting the edge component of the corresponding different frequency band of the scales 1 through 3 from the input image. Note that the number of pixels of the edge map 1 is ¼ (vertically ½×horizontally ½) of the input image, the number of pixels of the edge map 2 is 1/16 (vertically ¼×horizontally ¼) of the input image, and the number of pixels of the edge map 3 is 1/64(vertically ⅛×horizontally ⅛) of the input image.

The edge maps creating unit 11 supplies the created edge maps 1 through 3 to the dynamic range detecting unit 12 and the local maximums creating unit 14.

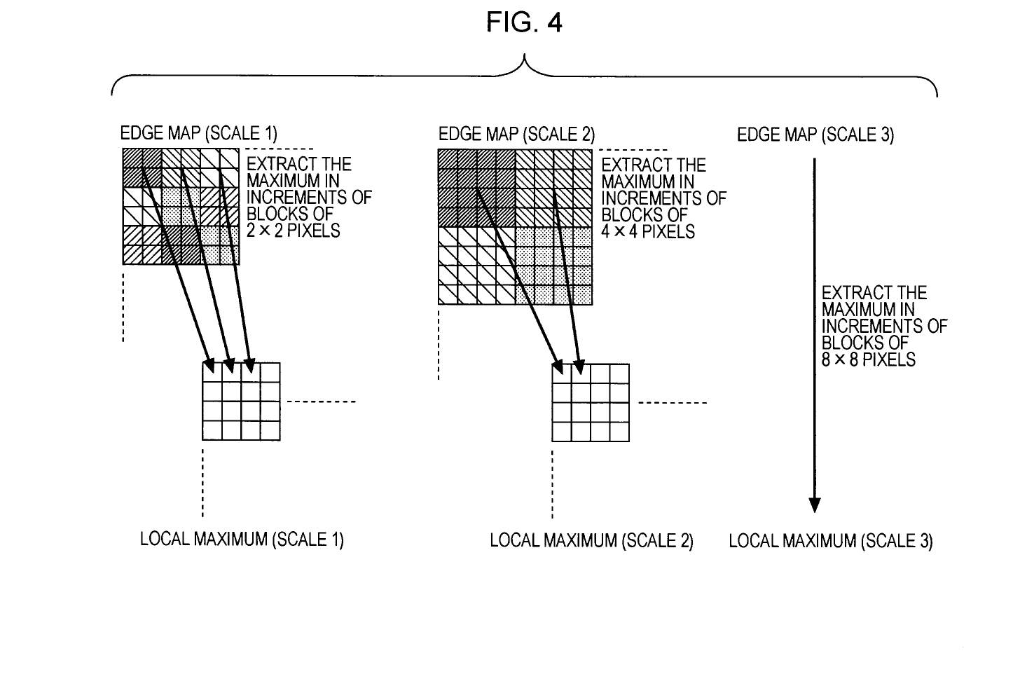

In step S2, the local maximums creating unit 14 creates local maximums. The local maximums creating unit 14 divides, such as shown on the left side in FIG. 4, the edge map 1 into blocks of 2×2 pixels, extracts the maximum value of each block, and arrays the extracted maximum values in the same sequence as the corresponding block, thereby creating a local maximum 1. Also, the local maximums creating unit 14 divides, such as shown at the center in FIG. 4, the edge map 2 into blocks of 4×4 pixels, extracts the maximum value of each block, and arrays the extracted maximum values in the same sequence as the corresponding block, thereby creating a local maximum 2. Further, the local maximums creating unit 14 divides, such as shown on the right side in FIG. 4, the edge map 3 into blocks of 8×8 pixels, extracts the maximum value of each block, and arrays the extracted maximum values in the same sequence as the corresponding block, thereby creating a local maximum 3. The local maximums creating unit 14 supplies the created local maximums 1 through 3 to the edge points extracting unit 15 and the edge analyzing unit 17.

In step S3, the dynamic range detecting unit 12 detects a dynamic range. Specifically, the dynamic range detecting unit 12 detects the maximum value and the minimum value of the pixel values from the edge maps 1 through 3, and detects a value obtained by subtracting the minimum value from the maximum value of the detected pixel values, i.e., difference between the maximum value and the minimum value of the edge intensities of the input image as a dynamic range. The dynamic range detecting unit 12 supplies information indicating the detected dynamic range to the computation parameters adjusting unit 13.

Note that, in addition to the above method, it can be conceived to detect a dynamic range for each edge map, and use the maximum value, mean value, or the like of the detected dynamic ranges as a dynamic range to be used actually.

In step S4, the computation parameters adjusting unit 13 determines whether or not the dynamic range is less than a predetermined threshold. In the case that the dynamic range is less than a predetermined threshold, i.e., the dynamic range is a low-dynamic range, the flow proceeds to step S5.

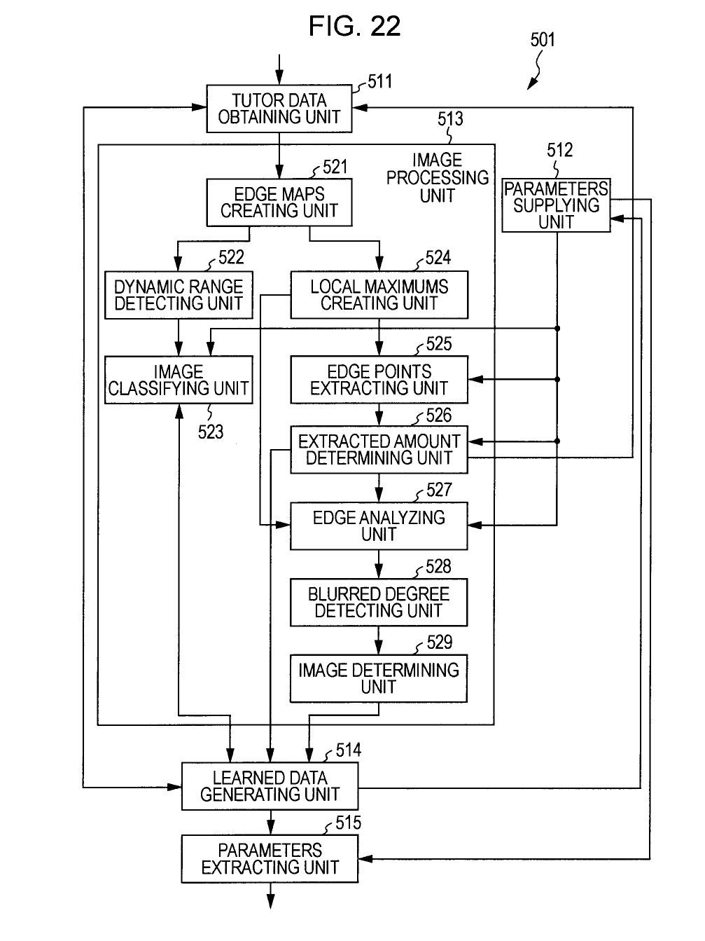

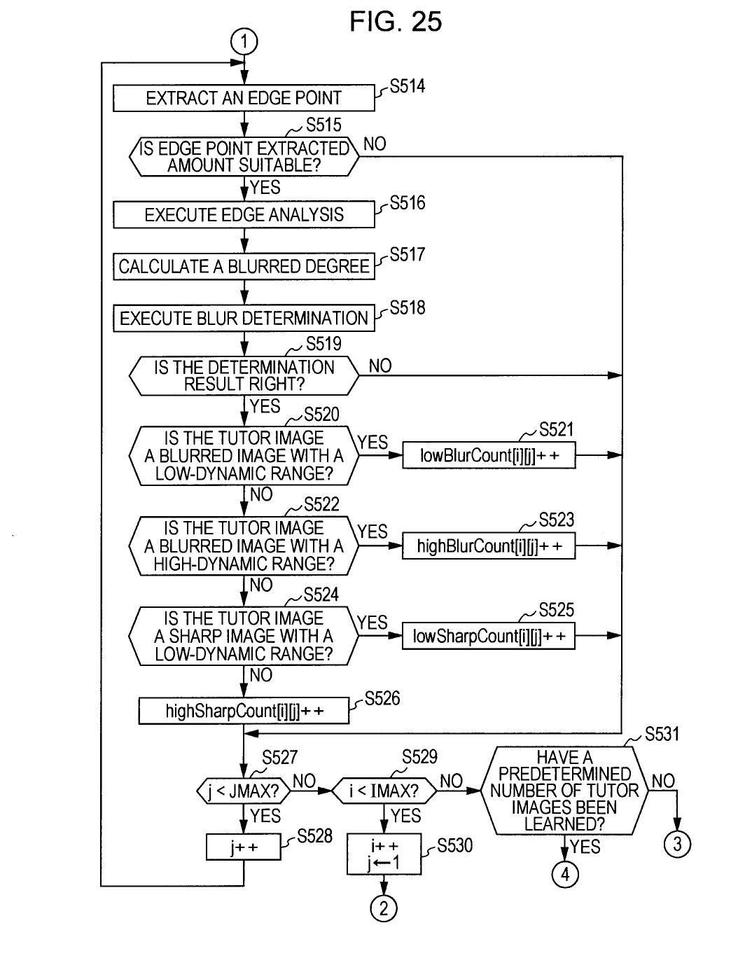

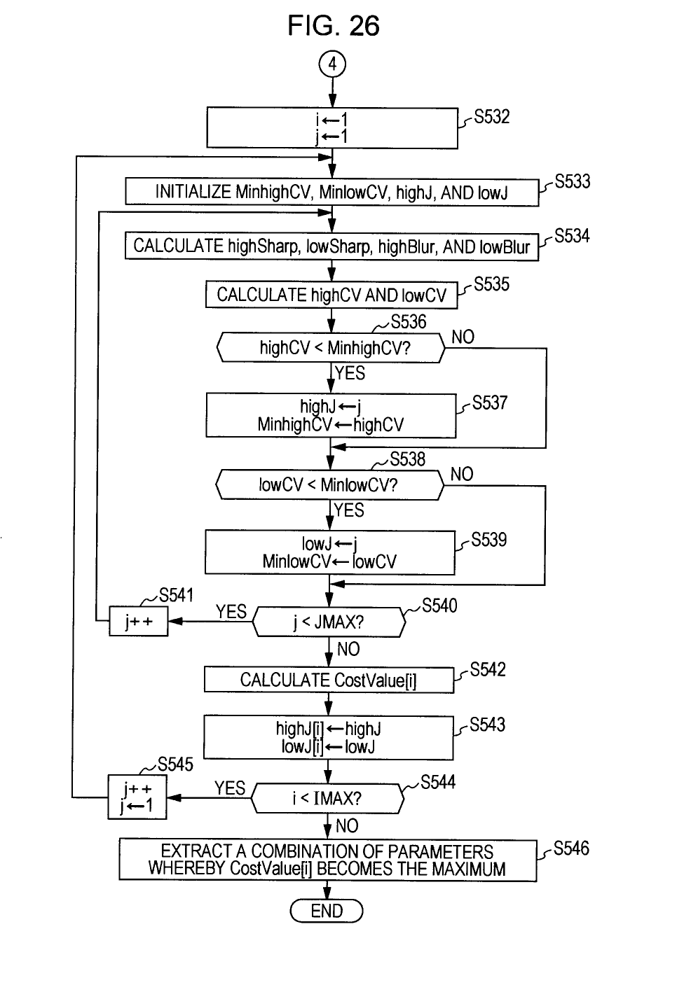

In step S5, the computation parameters adjusting unit 13 sets the computation parameters to a default value for a low-dynamic range image. That is to say, the computation parameters adjusting unit 13 sets the default values of the edge reference value and the extracted reference value to a value for a low-dynamic range image. Note that the default values of an edge reference value and an extracted reference value for a low-dynamic range image are obtained by later-described learning processing with reference to FIGS. 22 through 27. The computation parameters adjusting unit 13 supplies information indicating the edge reference value that has been set, to the edge points extracting unit 15 and the extracted amount determining unit 16, and supplies information indicating the extracted reference value that has been set, to the extracted amount determining unit 16.

In step S6, the edge points extracting unit 15 extracts an edge point. Specifically, if we say that one pixel of interest is selected from the input image, and the coordinates of the selected pixel of interest are (x, y), the edge points extracting unit 15 obtains coordinates (x₁, y₁) of the pixel of the local maximum 1 corresponding to the pixel of interest based on the following Expression (9).

(x₁,y₁)=(x/4,y/4) (9)

However, digits after decimal point are truncated.

That is to say, one pixel of the local maximum 1 is generated from a block of 4×4 pixels of the input image, and accordingly, the coordinates of the pixel of the local maximum 1 corresponding to the pixel of interest of the input image become values obtained by dividing the x coordinate and the y coordinate of the pixel of interest by 4.

Similarly, the edge points extracting unit 15 obtains coordinates (x₂, y₂) of the local maximum 2 corresponding to the pixel of interest, and coordinates (x₃, y₃) of the local maximum 3 corresponding to the pixel of interest, based on the following Expressions (10) and (11).

(x₂,y₂)=(x/16,y/16) (10)

(x₃,y₃)=(x/64,y/64) (11)

However, digits after decimal point are truncated.

In the case that the pixel value of the coordinates (x₁, y₁) of the local maximum 1 is equal to or greater than the edge reference value, the edge point extracting unit 15 extracts the pixel of interest as an edge point of the local maximum 1, and stores this by correlating the pixel values of the coordinates (x, y) of the pixel of interest, and the coordinates (x₁, y₁) of the local maximum 1. Similarly, in the case that the pixel value of the coordinates (x₂, m of the local maximum 2 is equal to or greater than the edge reference value, the edge point extracting unit 15 extracts the pixel of interest as an edge point of the local maximum 2, and stores this by correlating the pixel values of the coordinates (x, y) of the pixel of interest, and the coordinates (x₂, y₂) of the local maximum 2, and in the case that the pixel value of the coordinates (x₃, y₃) of the local maximum 3 is equal to or greater than the edge reference value, extracts the pixel of interest as an edge point of the local maximum 3, and stores this by correlating the pixel values of the coordinates (x, y) of the pixel of interest, and the coordinates (x₃, y₃) of the local maximum 3.

The edge points extracting unit 15 repeats the above processing until all the pixels of the input image become a pixel of interest, extracts a pixel included in a block of which the edge intensity is equal to or greater than the edge reference value of blocks of 4×4 pixels of the input image as an edge point based on the local maximum 1, extracts a pixel included in a block of which the edge intensity is equal to or greater than the edge reference value of blocks of 16×16 pixels of the input image as an edge point based on the local maximum 2, and extracts a pixel included in a block of which the edge intensity is equal to or greater than the edge reference value of blocks of 64×64 pixels of the input image as an edge point based on the local maximum 3. Accordingly, a pixel included in at least one of the blocks of 4×4 pixels, 16×16 pixels, and 64×64 pixels of the input image of which the edge intensity is equal to or greater than the edge reference value is extracted as an edge point.

The edge point extracting unit 15 creates an edge point table 1 that is a table in which the coordinates (x, y) of the edge point extracted based on the local maximum 1 are correlated with the pixel value of the pixel of the local maximum 1 corresponding to the edge point thereof, an edge point table 2 that is a table in which the coordinates (x, y) of the edge point extracted based on the local maximum 2 are correlated with the pixel value of the pixel of the local maximum 2 corresponding to the edge point thereof, and an edge point table 3 that is a table in which the coordinates (x, y) of the edge point extracted based on the local maximum 3 are correlated with the pixel value of the pixel of the local maximum 3 corresponding to the edge point thereof, and supplies these to the extracted amount determining unit 16.

In step S7, the extracted amount determining unit 16 determines whether or not the edge point extracted amount is suitable. The extracted amount determining unit 16 compares the number of total of the extracted edge points, i.e., the total of the number of data of the edge point tables 1 through 3, and the extracted reference value, and in the case that the total is less than the extracted reference value, determines that the edge point extracted amount is not suitable, and the flow proceeds to step S8.

In step S8, the computation parameters adjusting unit 13 adjusts the computation parameters. Specifically, the extracted amount determining unit 16 notifies the computation parameters adjusting unit 13 that the edge point extracted amount is not suitable. The computation parameters adjusting unit 13 reduces the edge reference value by a predetermined value so as to extract more edge points than the current edge points. The computation parameters adjusting unit 13 supplies information indicating the adjusted edge reference value to the edge points extracting unit 15 and the extracted amount determining unit 16.

Subsequently, the flow returns to step S6, the processing in steps S6 through S8 is repeatedly executed until determination is made in step S7 that the edge point extracted amount is suitable. That is to say, the processing for extracting an edge point while adjusting the edge reference value to create edge point tables 1 through 3 is repeated until the edge point extracted amount becomes a suitable value.

On the other hand, in the case that the total number of the extracted edge points is equal to or greater than the extracted reference value in step S7, the extracted amount determining unit 16 determines that the edge point extracted amount is suitable, and the flow proceeds to step S13.

Also, in the case that determination is made in step S4 that the dynamic range is equal to or greater than a predetermined threshold, i.e., a high-dynamic range, the flow proceeds to step S9.

In step S9, the computation parameters adjusting unit 13 sets the computation parameters to a default value for a high-dynamic image. That is to say, the computation parameters adjusting unit 13 sets the default values of the edge reference value and the extracted reference value to a value for a high-dynamic range image. Note that the default values of an edge reference value and an extracted reference value for a high-dynamic range image are obtained by later-described learning processing with reference to FIGS. 22 through 27. The computation parameters adjusting unit 13 supplies information indicating the edge reference value that has been set, to the edge points extracting unit 15 and the extracted amount determining unit 16, and supplies information indicating the extracted reference value that has been set, to the extracted amount determining unit 16.

In step S10, in the same way as with the processing in step S6, edge point tables 1 through 3 are created, and the created edge point tables 1 through 3 are supplied to the extracted amount determining unit 16.

In step S11, in the same way as with the processing in step S7, determination is made whether or not the edge point extracted amount is suitable, and in the case that the edge point extracted amount is not suitable, the flow proceeds to step S12.

In step S12, in the same way as with the processing in step S8, the computation parameters are adjusted, and subsequently, the flow returns to step S10, where the processing in steps S10 through S12 is repeatedly executed until determination is made in step S11 that the edge point extracted amount is suitable.

On the other hand, in the case that determination is made in step S11 that the edge point extracted amount is suitable, the flow proceeds to step S13.

Note that, in order to improve the detection precision of a blurred degree according to the above processing, with regard to a low-dynamic range input image, an edge point is extracted even from a block of which the edge intensity is weak so as to secure a sufficient amount of edge points for obtaining a certain level or more of the detection precision of the blurred degree of the input image, and with regard to a high-dynamic range input image, an edge point is extracted from a block of which the edge intensity is strong as much as possible so as to extract edge points making up a stronger edge.

In step S13, the edge analyzing unit 17 executes edge analysis. Specifically, the extracted amount determining unit 16 supplies the edge reference value at the time of determining that the edge point extracted amount is suitable, and the edge point tables 1 through 3 to the edge analyzing unit 17.

The edge analyzing unit 17 selects one of the edge points extracted from the input image as a pixel of interest, based on the edge point tables 1 through 3. In the case that the coordinates of the selected pixel of interest are taken as (x, y), the edge analyzing unit 17 obtains the coordinates (x₁, y₁) through (x₃, y₃) of the pixels of the local maximums 1 through 3 corresponding to the pixel of interest based on the above-described Expressions (9) through (11). The edge analyzing unit 17 sets the maximum value of the pixel values within a block of m×m pixels (e.g., 4×4 pixels) with the pixel of the coordinates (x₁, y₁) of the local maximum 1 as the upper left corner pixel to Local max₁(x₁, y₁), sets the maximum value of the pixel values within a block of n×n pixels (e.g., 2×2 pixels) with the pixel of the coordinates (x₂, y₂) of the local maximum 2 as the upper left corner pixel to Local Max₂(x₂, y₂), and sets the pixel value of the coordinates (x₃, y₃) of the local maximum 3 to Local Max₃(x₃, y₃).

Note that the parameters of m×m used for setting of Local max₁(x₁, y₁), and the parameters of n×n used for setting of Local Max₂(x₂, y₂) are parameters for adjusting difference the sizes of blocks of the input image corresponding to one pixel of the local maximums 1 through 3.

The edge analyzing unit 17 determines whether or not Local max₁ (x₁, y₁), Local Max₂(x₂, y₂), and Local Max₃(x₃, y₃) satisfy the following Conditional Expression (12). In the case that Local max₁ (x₁, y₁), Local Max₂(x₂, y₂), and Local Max₃(x₃, y₃) satisfy Conditional Expression (12), the edge analyzing unit 17 increments the value of a variable N_{edge} by one.

Local Max₁(x₁,y₁)>edge reference value or

Local Max₂(x₂,y₂)>edge reference value or

Local Max₃(x₃,y₃)>edge reference value (12)

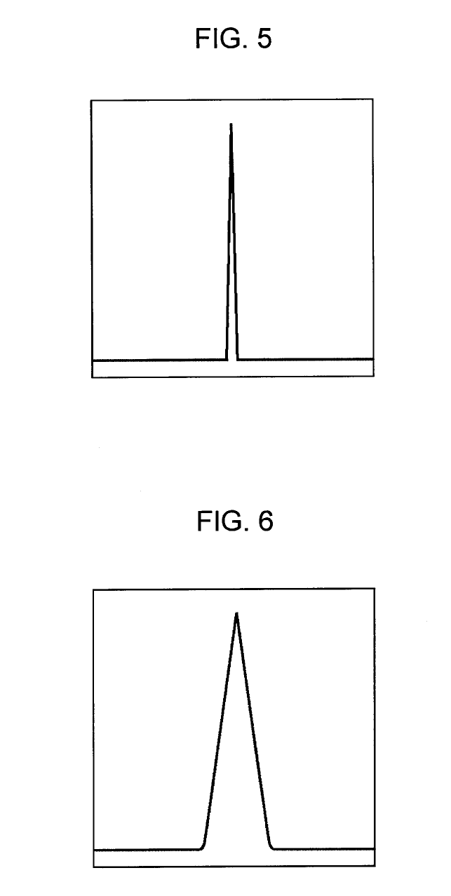

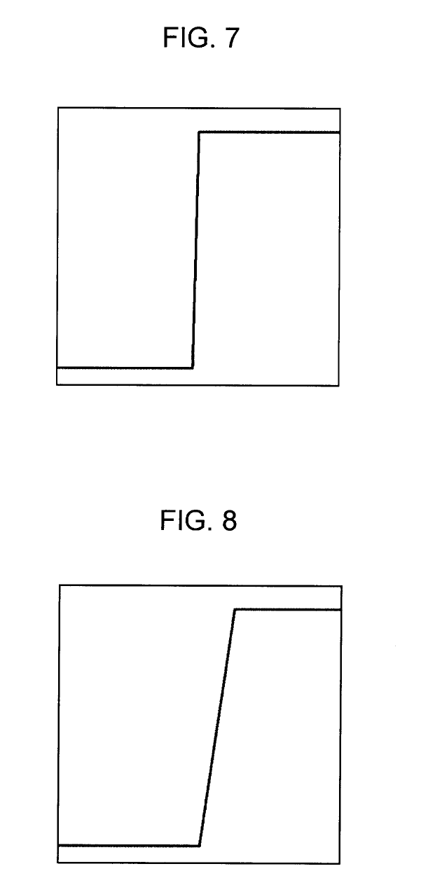

Note that an edge point satisfying Conditional Expression (12) is assumed to be an edge point making up an edge having certain or more intensity regardless of the configuration thereof, such as an edge having a steep impulse shape shown in FIG. 5, a pulse-shaped edge shown in FIG. 6 of which the inclination is more moderate than the edge in FIG. 5, an stepped edge of which the inclination shown in FIG. 7 is almost perpendicular, a stepped edge of which the inclination shown in FIG. 7 is more moderate than the edge shown in FIG. 8, or the like.

Also, in the case that Local Max₁ (x₁, y₁), Local Max₂(x₂, y₂), and Local Max₃(x₃, y₃) satisfy Conditional Expression (12), the edge analyzing unit 17 further determines whether or not Local Max₁(x₁, y₁), Local Max₂(x₂, y₂), and Local Max₃(x₃, y₃) satisfy Conditional Expression (13) or (14). In the case that Local Max₁ (x₁, y₁), Local Max₂(x₂, y₂), and Local Max₃(x₃, y₃) satisfy Conditional Expression (13) or (14), the edge analyzing unit 17 increments the value of a variable N_{smallblur} by one.

Local Max₁(x₁,y₁)<Local Max₂ (x₂,y₂)<Local Max₃(x₃,y₃) (13)

Local Max₂(x₂,y₂)>Local Max₁(x₁,y₁)

and

Local Max₂(x₂,y₂)>Local Max₃(x₃,y₃) (14)

Note that an edge point satisfying Conditional Expression (12) and also satisfying Conditional Expression (13) or (14) is assumed to be an edge point making up an edge having the configuration in FIG. 6 or 8 which has certain or more intensity but weaker intensity than the edge in FIG. 5 or 7.

Further, in the case that Local Max₁ (x₁, y₁), Local Max₂(x₂, y₂), and Local Max₃(x₃, y₃) satisfy Conditional Expression (12), and also satisfy Conditional Expression (13) or (14), the edge analyzing unit 17 determines whether or not Local Max₁(x₁, y₁) satisfies the following Conditional Expression (15). In the case that Local Max₁(x₁, y₁) satisfies Conditional Expression (15), the edge analyzing unit 17 increments the value of a variable N_{largeblur} by one.

Local Max₁(x₁,y₁)>edge reference value (15)

Note that an edge point satisfying Conditional Expression (12), and also satisfying Conditional Expression (13) or (14), and also satisfying Conditional Expression (15) is assumed to be an edge point making up an edge where blur occurs and sharpness is lost, of edges having the configuration in FIG. 6 or 8 with certain or more intensity. In other words, assumption is made wherein blur occurs at the edge point thereof.

The edge analyzing unit 17 repeats the above processing until all the edge points extracted from the input image become a pixel of interest. Thus, of the extracted edge points, the number of edge points N_{edge} satisfying Conditional Expression (13), the number of edge points N_{smallblur} satisfying Conditional Expression (12), and also satisfying Conditional Expression (13) or (14), and the number of edge points N_{largeblur} satisfying Conditional Expression (15) are obtained. The edge analyzing unit 17 supplies information indicating the calculated N_{smallblur} and N_{largeblur} to the blurred degree detecting unit 18.

In step S14, the blurred degree detecting unit 18 detects a blurred degree BlurEstimation serving as an index of the blurred degree of the input image based on the following Expression (16).

$$BlurEstimation = \frac{{N}_{largeblur}}{{N}_{smallblur}} \qquad ( 16 )$$

That is to say, the blurred degree BlurEstimation is a ratio where edge points estimated to make up an edge where blur occurs are occupied of edge points estimated to make up an edge having the configuration in FIG. 6 or 8 with certain or more intensity. Accordingly, estimation is made that the greater the blurred degree BlurEstimation is, the greater the blurred degree of the input image is, and the smaller the blurred degree BlurEstimation is, the smaller the blurred degree of the input image is.

The blurred degree detecting unit 18 externally outputs the detected blurred degree BlurEstimation, and ends the blurred degree detecting processing. For example, an external device compares the blurred degree BlurEstimation and a predetermined threshold, thereby determining whether or not the input image blurs.

Note that the details of the processing in steps S13 and S14 are described in Hanghang Tong, Mingiing Li, Hongiiang Zhang, Changshui Zhang, “Blur Detection for Digital Images Using Wavelet Transform”, Multimedia and Expo. 2004, ICME '04, 2004 IEEE International Conference on 27-30 Jun. 2004, page(s) 17-20.

As described above, conditions for extracting edge points, and the extracted amount of edge points are suitably controlled according to the input image, and accordingly, the blurred degree of the input image can be detected with higher precision.

Also, edge intensity is detected without executing a complicated computation such as wavelet transform or the like, and accordingly, time used for detection of edge intensity can be reduced as compared to the invention described in Hanghang Tong, Mingiing Li, Hongiiang Zhang, Changshui Zhang, “Blur Detection for Digital Images Using Wavelet Transform”, Multimedia and Expo. 2004, ICME '04, 2004 IEEE International Conference on 27-30 Jun. 2004, page(s) 17-20.

### 2. Modification of First Embodiment

Note that, with the above description, in the case of creating edge maps, an example has been shown wherein the mean of the edge intensities in the three directions of the vertical, horizontal, and oblique directions is obtained, but for example, the mean of the edge intensities in one direction or two directions may be obtained.

Also, with the above description, an example has been shown wherein the input image is classified into the two types of a low dynamic range and a high dynamic range to execute processing, but the input image may be classified into three types or more according to the range of a dynamic range to execute processing. Thus, the blurred degree of the input image can be detected with higher precision.

Further, with the above description, an example has been shown wherein in the case that the amount of the extracted edge points is too small, the edge reference value is reduced so as to extract many more edge points, and further, the edge reference value may be increased in the case that the amount of the extracted edge points is too great so as to reduce the amount of edge points to be extracted. That is to say, the edge reference value may be adjusted in a direction where the extracted amount of edge points becomes suitable amount.

Also, for example, in the case that the input image is determined to be a low-dynamic range input image, when the amount of the extracted edge points is too great, the input image may be processed as a high-dynamic range input image.

Also, the size of a block in the above case of creating edge maps and local maximums is an example thereof, and may be set to a size different from the above size.

### 3. Second Embodiment

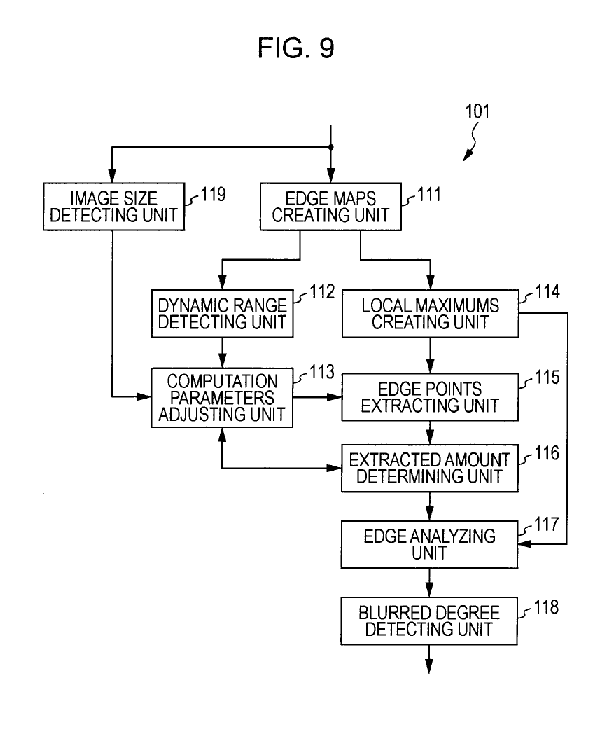

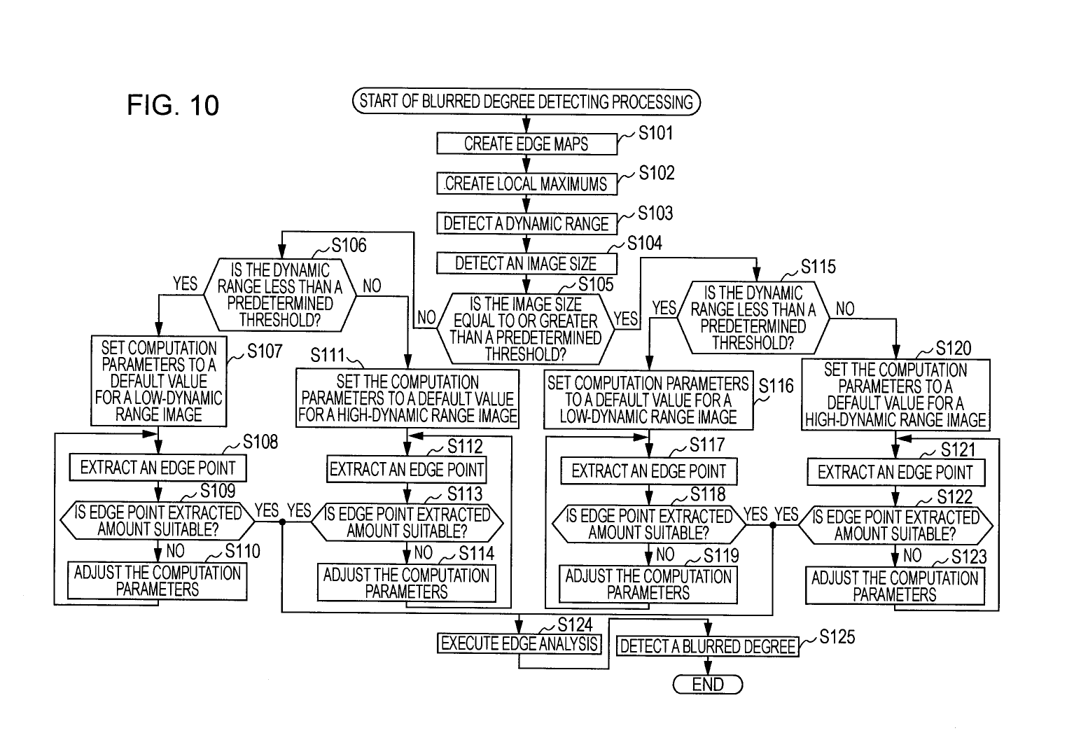

Next, a second embodiment of an image processing apparatus to which the present invention has been applied will be described with reference to FIGS. 9 and 10. Note that, with the second embodiment of the image processing apparatus, in addition to the dynamic range of the input image, settings of the default values of the edge reference value and the extracted reference value are executed while the image size of the input image is taken into consideration.

### Functional Configuration Example of Image Processing Apparatus

FIG. 9 is a block diagram illustrating a configuration example of the function of an image processing apparatus 101 serving as the second embodiment of the image processing apparatus to which the present invention has been applied.

The image processing apparatus 101 is configured so as to include an edge maps creating unit 111, a dynamic range detecting unit 112, a computation parameters adjusting unit 113, a local maximums creating unit 114, an edge points extracting unit 115, an extracted amount determining unit 116, an edge analyzing unit 117, a blurred degree detecting unit 118, and an image size detecting unit 119. Note that, in the drawing, the portions corresponding to those in FIG. 1 are denoted with reference numerals of which the lower two digits are the same, and with regard to the portions of which the processing is the same, redundant description thereof will be omitted.

The image size detecting unit 119 detects the image size (number of pixels) of the input image, and supplies information indicating the detected image size of the input image to the computation parameters adjusting unit 113.

The computation parameters adjusting unit 113 adjusts, such as described later with reference to FIG. 10, computation parameters including the edge reference value and the extracted reference value based on the detected image size and dynamic range of the input image. The computation parameters adjusting unit 113 supplies information indicating the edge reference value that has been set, to the edge points extracting unit 115 and the extracted amount determining unit 116, and supplies information indicating the extracted reference value that has been set, to the extracted amount determining unit 116.

### Description of Operation

Next, blurred degree detecting processing to be executed by the image processing apparatus 101 will be described with reference to the flowchart in FIG. 10. Note that this processing is started, for example, when an input image serving as a detected target is input to the edge maps creating unit 111 and the image size detecting unit 119.

Processing in steps S101 through S103 is the same as the processing in steps S1 through S3 in FIG. 2, so redundant description thereof will be omitted. Note that, according to such processing, edge maps and local maximums of the input image are created, and the dynamic range of the input image is detected.

In step S104, the image size detecting unit 119 detects an image size. For example, the image size detecting unit 119 detects the number of pixels in the vertical direction and the horizontal direction of the input image as an image size. The image size detecting unit 119 supplies information indicating the detected image size to the computation parameters adjusting unit 113.

In step S105, the computation parameters adjusting unit 113 determines whether or not the image size is equal to or greater than a predetermined threshold. In the case that the number of pixels of the input image is less than a predetermined threshold (e.g., 256×256 pixels), the computation parameters adjusting unit 113 determines that the image size is less than the predetermined threshold, and the flow proceeds to step S106.

Processing in steps S106 through S114 is the same as the processing in steps S4 through S12 in FIG. 2, so redundant description thereof will be omitted. Note that, according to such processing, an edge point is extracted from the input image of which the image size is less than the predetermined threshold while adjusting the edge reference value and the extracted reference value. Subsequently, the flow proceeds to step S124.

On the other hand, in the case that determination is made in step S105 that the image size is equal to or greater than the predetermined threshold, the flow proceeds to step S115.

Processing in steps S115 through S123 is the same as the processing in steps S4 through S12 in FIG. 2, so redundant description thereof will be omitted. Note that, according to such processing, an edge point is extracted from the input image of which the image size is equal to or greater than the predetermined threshold while adjusting the edge reference value and the extracted reference value. Subsequently, the flow proceeds to step S124.

Note that the default values of the edge reference value and the extracted reference value that are set in steps S107, S111, S116, and S120 are selected from a combination of the default values of four types of edge reference value and extracted reference value based on the image size and dynamic range of the input image, and are set.

For example, the greater the image size is, the greater the default value of the extracted reference value is set. Accordingly, in the case of the same low-dynamic range images, when the image size is less than the predetermined threshold, the default value of the extracted reference value is set to a smaller value as compared to the case of the image size being equal to or greater than the predetermined threshold. This is true for the case of high-dynamic range images.

This is assumed that in the case of the same dynamic range images, the smaller the image size is, the fewer the number of edges within the image is, and the less the amount of edge points to be extracted is. Accordingly, in the case of attempting to extract the same number of edge points from an image of which the image size is small as that of an image of which the image size is great, the extraction precision of edge points may deteriorate. In order to prevent this, when the image size is less than the predetermined threshold, the default value of the extracted reference value is set to a smaller value as compared to the case of the image size being equal to or greater than the predetermined threshold.

Processing in steps S124 through S125 is the same as the processing in steps S13 through S14 in FIG. 2, so redundant description thereof will be omitted. Note that, according to such processing, edge analysis of each pixel of the input image is executed, and the blurred degree BlurEstimation of the input image is detected based on the results of the edge analysis. Subsequently, the blur detecting processing ends.

As described above, the default values of the edge reference value and the extracted reference value are set while considering not only the dynamic range of the input image but also the image size thereof, and accordingly, the blurred degree of the input image can be detected with higher precision.

### 4. Modification of Second Embodiment

Note that, with the above description, an example has been shown wherein the image size of the input image is classified into the two types to execute processing, but the default value of the extracted reference value may be set by classifying the image size of the input image into three types or more.

Also, the default value of the edge reference value may be changed according to the image size of the input image.

Further, the threshold used for classification of the dynamic range of the input image may be changed according to the image size of the input image.

Also, with the above description, an example has been shown wherein the image size of the input image is classified, and then the dynamic range of the input image is classified, but the processing sequence thereof may be inverted.

### 5. Third Embodiment

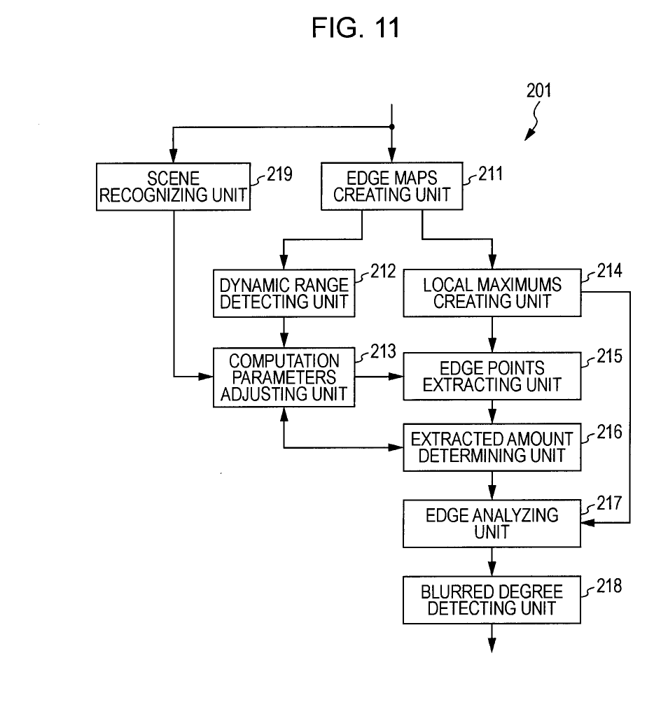

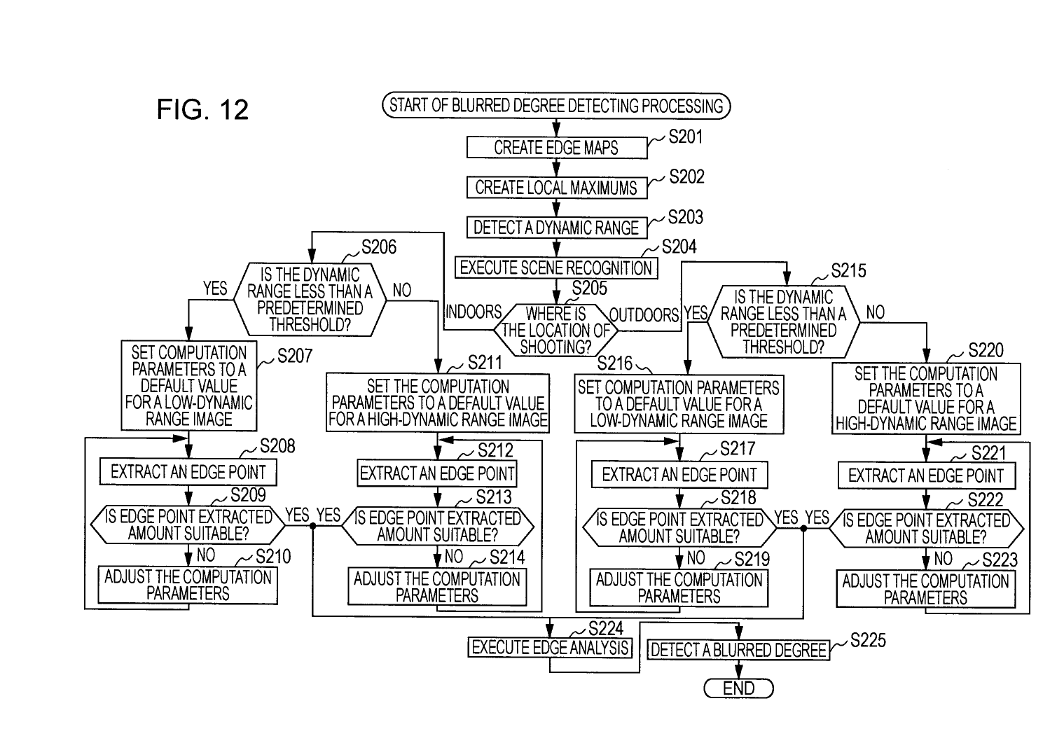

Next, a third embodiment of an image processing apparatus to which the present invention has been applied will be described with reference to FIGS. 11 and 12. Note that, with the third embodiment of the image processing apparatus, in addition to the dynamic range of the input image, settings of the default values of the edge reference value and the extracted reference value are executed while the shot scene of the input image is taken into consideration.

### Functional Configuration Example of Image Processing Apparatus

FIG. 11 is a block diagram illustrating a configuration example of the function of an image processing apparatus 201 serving as the third embodiment of the image processing apparatus to which the present invention has been applied.

The image processing apparatus 201 is configured so as to include an edge maps creating unit 211, a dynamic range detecting unit 212, a computation parameters adjusting unit 213, a local maximums creating unit 214, an edge points extracting unit 215, an extracted amount determining unit 216, an edge analyzing unit 217, a blurred degree detecting unit 218, and a scene recognizing unit 219. Note that, in the drawing, the portions corresponding to those in FIG. 1 are denoted with reference numerals of which the lower two digits are the same, and with regard to the portions of which the processing is the same, description thereof will be redundant, and accordingly omitted.

The scene recognizing unit 219 uses a predetermined scene recognizing method to recognize the shot scene of the input image. For example, the scene recognizing unit 219 recognizes whether the input image is taken indoors or outdoors. The scene recognizing unit 219 supplies information indicating the recognized result to the computation parameters adjusting unit 213.

The computation parameters adjusting unit 213 adjusts, such as described later with reference to FIG. 12, computation parameters including the edge reference value and the extracted reference value based on the detected shot scene and dynamic range of the input image. The computation parameters adjusting unit 213 supplies information indicating the edge reference value that has been set, to the edge points extracting unit 215 and the extracted amount determining unit 216, and supplies information indicating the extracted reference value that has been set, to the extracted amount determining unit 216.

### Description of Operation

Next, blurred degree detecting processing to be executed by the image processing apparatus 201 will be described with reference to the flowchart in FIG. 12. Note that this processing is started, for example, when an input image serving as a detected target is input to the edge maps creating unit 211 and the scene recognizing unit 219.

Processing in steps S201 through S203 is the same as the processing in steps S1 through S3 in FIG. 2, so redundant description thereof will be omitted. Note that, according to such processing, edge maps and local maximums of the input image are created, and the dynamic range of the input image is detected.

In step S204, the scene recognizing unit 219 executes scene recognition. Specifically, the scene recognizing unit 219 uses a predetermined scene recognizing method to recognize whether the input image has been taken indoors or outdoors. The scene recognizing unit 219 supplies information indicating the recognized result to the computation parameters adjusting unit 213.

In step S205, the computation parameters adjusting unit 213 determines whether the location of shooting is indoor or outdoor. In the case that determination is made that the location of shooting is indoor, the flow proceeds to step S206.

Processing in steps S206 through S214 is the same as the processing in steps S4 through S12 in FIG. 2, so redundant description thereof will be omitted. Note that, according to such processing, an edge point is extracted from the input image of which the image size is less than a predetermined threshold while adjusting the edge reference value and the extracted reference value. Subsequently, the flow proceeds to step S224.

On the other hand, in the case that determination is made in step S205 that the location of shooting is outdoor, the flow proceeds to step S215.

Processing in steps S215 through S223 is the same as the processing in steps S4 through S12 in FIG. 2, so redundant description thereof will be omitted. Note that, according to such processing, an edge point is extracted from the input image of which the image size is equal to or greater than the predetermined threshold while adjusting the edge reference value and the extracted reference value. Subsequently, the flow proceeds to step S224.

Note that the default values of the edge reference value and the extracted reference value that are set in steps S207, S211, S216, and S220 are selected from a combination of the default values of four types of edge reference value and extracted reference value based on the location of shooting and dynamic range of the input image, and are set.

Processing in steps S224 through S225 is the same as the processing in steps S13 through S14 in FIG. 2, so redundant description thereof will be omitted. Note that, according to such processing, edge analysis of each pixel of the input image is executed, and the blurred degree BlurEstimation of the input image is detected based on the results of the edge analysis. Subsequently, the blur detecting processing ends.

As described above, the default values of the edge reference value and the extracted reference value are set while considering not only the dynamic range of the input image but also the location of shooting thereof, and accordingly, the blurred degree of the input image can be detected with higher precision.

### 6. Modification of Third Embodiment

Note that, with the above description, an example has been shown wherein the location of shooting of the input image is classified into the two types to execute processing, but the default values of the computation parameters may be set by classifying the location of shooting into three types or more.

Also, the input image may be classified using the parameters of another shot scene other than the location of shooting. For example, the input image may be classified by time of shooting (e.g., daytime or night), weather (e.g., fine, cloudy, rainy, snowy), or the like to set the default values of the computation parameters. Further, the input image may be classified by combining the parameters of multiple shot scenes to set the default values of the computation parameters.

Further, the input image may be classified by combining the image size and shot scenes of the input image to set the default values of the computation parameters.

Also, the threshold used for classification of the dynamic range of the input image may be changed according to the shot scene of the input image.

Further, with the above description, an example has been shown wherein the shot scene is classified, and then the dynamic range of the input image is classified, but the processing sequence thereof may be inverted.

### 4. Fourth Embodiment

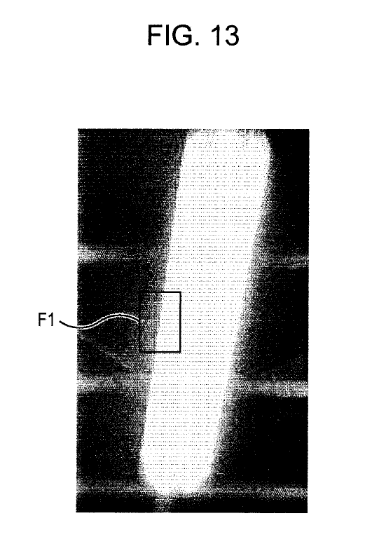

Next, a fourth embodiment of an image processing apparatus to which the present invention has been applied will be described with reference to FIGS. 13 through 21. Note that, with the fourth embodiment of the image processing apparatus, the input image is subjected to countermeasures for improving the detection precision of a blurred degree in the case that over exposure occurs on the input image.

### Problems in the Case of Over Exposure Occurring on the Input Image

In the case of over exposure occurring on the input image, change in a pixel value is smaller than change in the brightness of an actual subject with a portion where over exposure occurs regardless of no blur occurring. Accordingly, the detection precision of the blurred degree BlurEstimation may deteriorate. Description will be made specifically regarding this with reference to FIGS. 13 through 18.

FIG. 13 illustrates an example of the input image in the case that over exposure occurs at a fluorescent light and the surroundings thereof. That is to say, the fluorescent light is too bright, the pixel values of the fluorescent light and the surroundings thereof become the maximum value or a value approximate to the maximum value, and change in the pixel values is small as to change in the brightness of an actual subject.

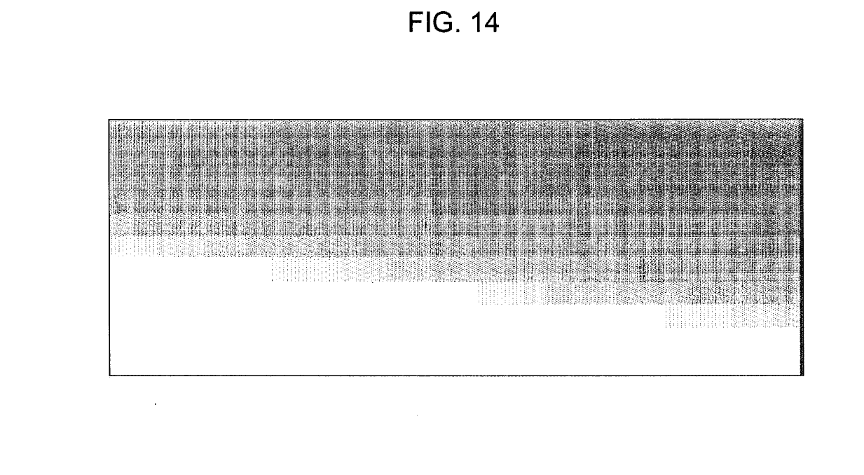

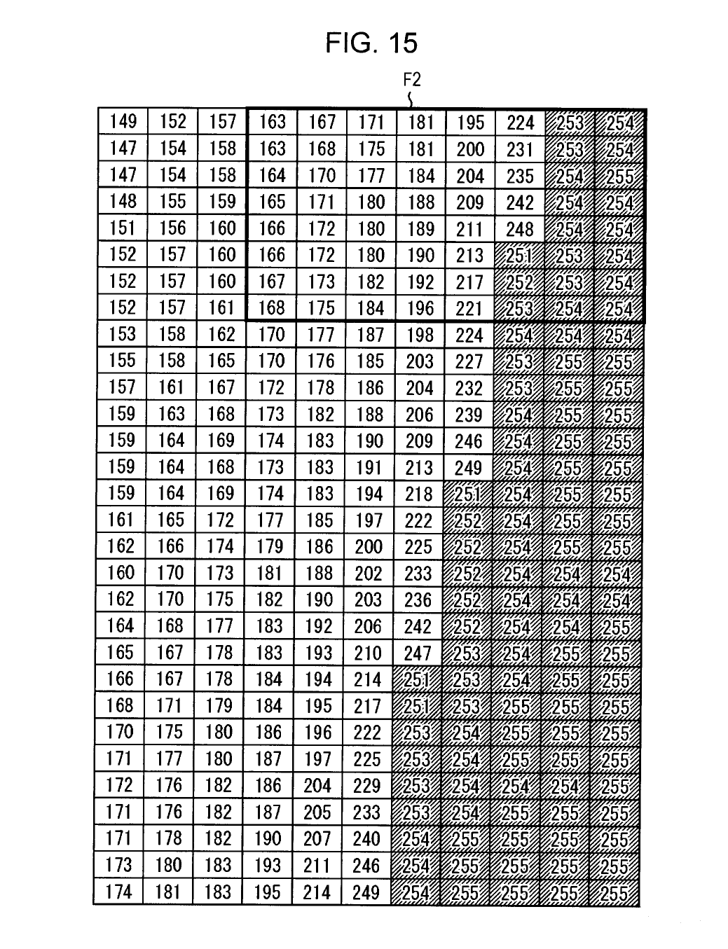

FIG. 14 is an enlarged view where a portion surrounded with the frame F1 of the input image in FIG. 13, i.e., around an edge of the fluorescent light is enlarged, and FIG. 15 illustrates the distribution of the pixel values in the enlarged view in FIG. 14. Note that a portion indicated with hatched lines in FIG. 15 indicates pixels of which the pixel values are 250 or more.

Description will be made while focusing on a portion surrounded with a frame F2 in FIG. 15 (hereafter, referred to as “image F2”).

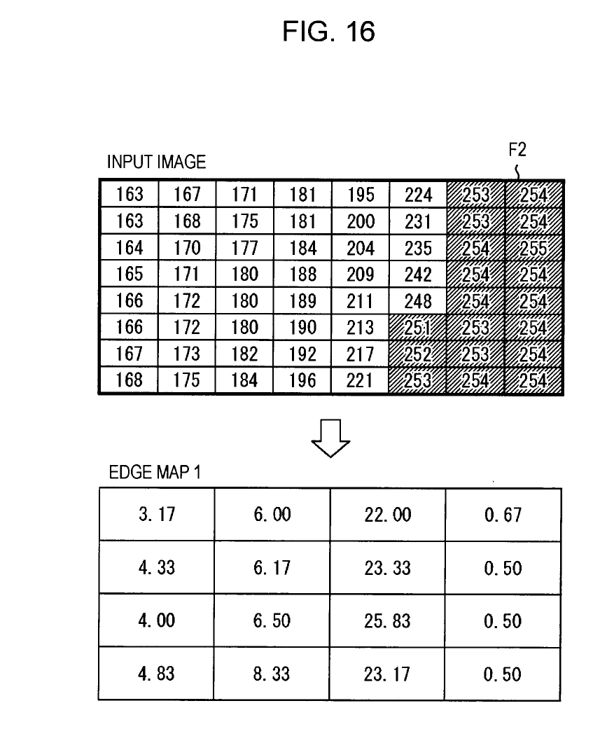

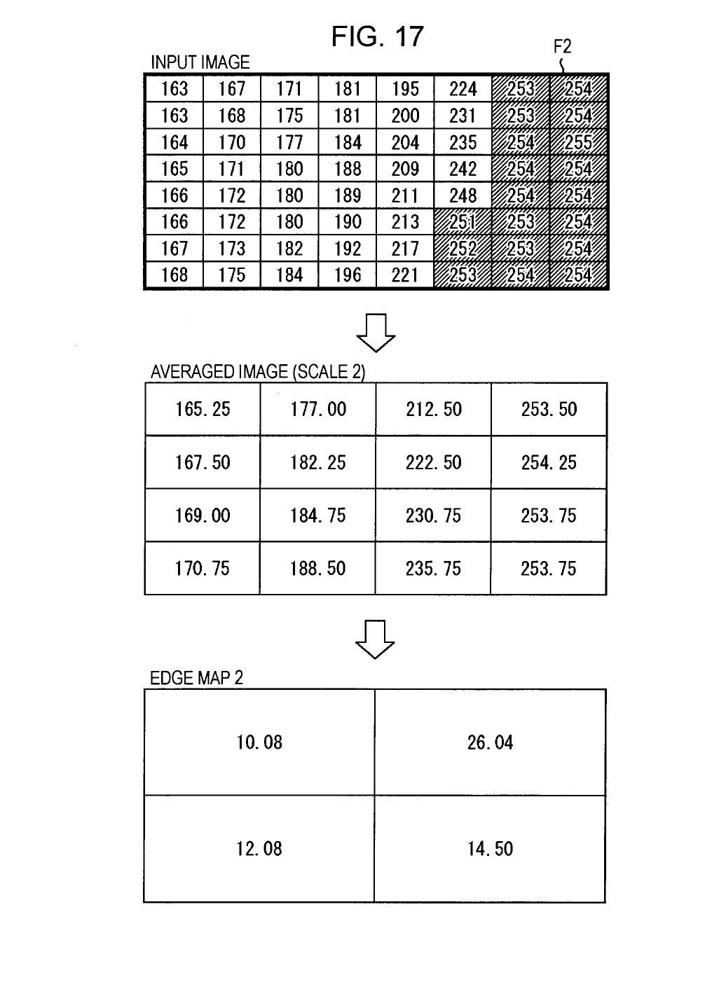

The diagram below FIG. 16 illustrates the distribution of the pixel values of the edge map 1 corresponding to the image F2. Also, the diagram in the middle of FIG. 17 illustrates the distribution of the pixel values of the averaged image of the scale 2 corresponding to the image F2, and the lowermost diagram illustrates the distribution of the pixel values of the edge map 2 corresponding to the image F2.

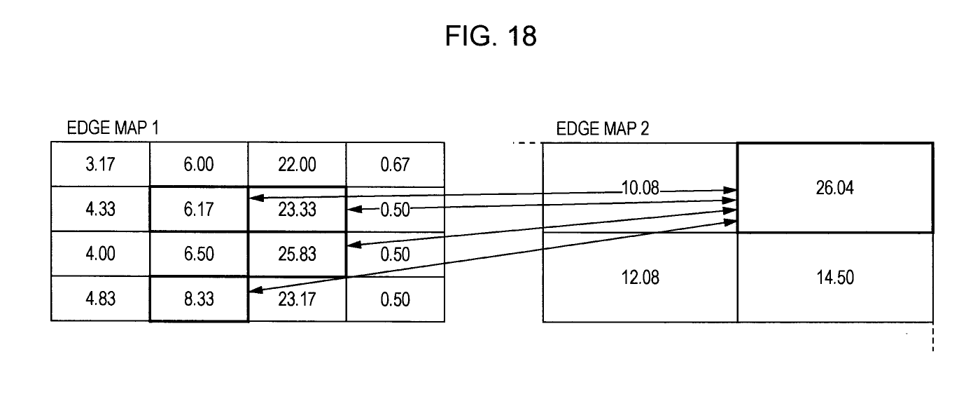

With the averaged image of the scale 2, there is a tendency wherein at around the border between a portion where over exposure occurs and a portion where over exposure does not occur, the pixel values of the portion including over exposure become great, and the pixel values of the portion not including over exposure become small. Therefore, there is a tendency wherein at around the border between the portion where over exposure occurs and the portion where over exposure does not occur, the pixel values of the edge map 2 become great. Accordingly, in the case of comparing the edge map 1 and the edge map 2 corresponding to the same portion of the input image, the pixel value of the edge map 2 is frequently greater than the pixel value of the edge map 1. For example, in the case of comparing the edge map 1 and the edge map 2 corresponding to the image F2, such as a portion indicated with a thick frame in FIG. 18, the pixel value of the edge map 2 is greater than the pixel value of the edge map 1. Note that, the pixels indicated with a thick frame in FIG. 18 illustrate pixels to be extracted as the pixels of the local maximum 1 with a pixel value within a block of 2×2 pixels of the edge map 1 becoming the maximum, and illustrates pixels to be extracted as the pixels of the local maximum 2 with a pixel within a block of 4×4 pixels of the edge map 2 (however, only a range of 2×2 pixels is shown in the drawing) becoming the maximum.

Accordingly, with the input image where over exposure occurs, there is a tendency wherein the above Conditional Expression (13) or (14) is satisfied, and the value of the variable N_{largeblur} becomes great. As a result thereof, the value of the denominator of the above Expression (16) becomes great, the value of the blurred degree BlurEstimation becomes smaller than the actual value, and accordingly, there is a high proportion that a blur image is erroneously determined not to be a blur image.

As described later, with the fourth embodiment of the image processing apparatus, the input image is subjected to countermeasures for improving the detection precision of the blurred degree BlurEstimation in the case that over exposure occurs on the input image while considering the above.

### Functional Configuration Example of Image Processing Apparatus

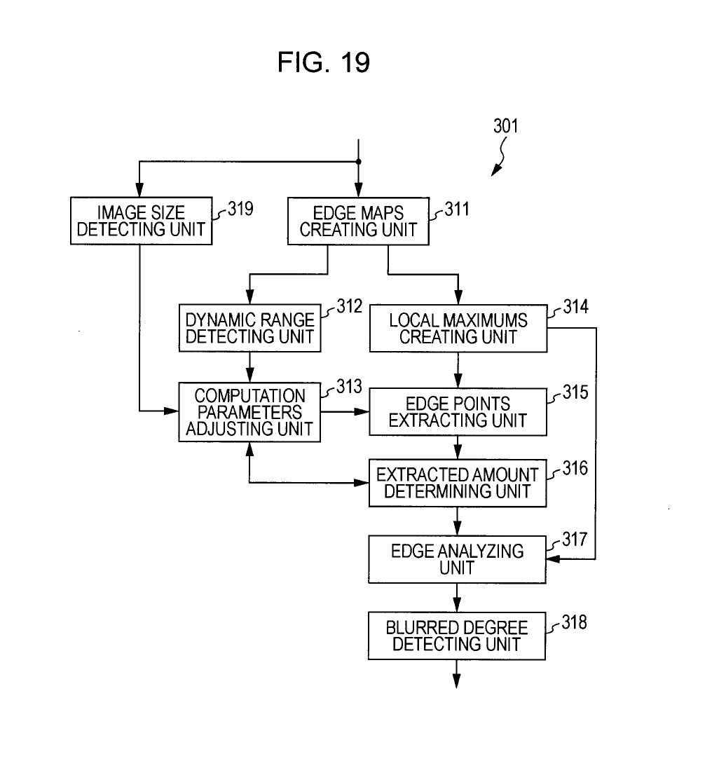

FIG. 19 is a block diagram illustrating a configuration example of the function of an image processing apparatus 301 serving as the fourth embodiment of the image processing apparatus to which the present invention has been applied.

The image processing apparatus 301 is configured so as to include an edge maps creating unit 311, a dynamic range detecting unit 312, a computation parameters adjusting unit 313, a local maximums creating unit 314, an edge points extracting unit 315, an extracted amount determining unit 316, an edge analyzing unit 317, a blurred degree detecting unit 318, and an image size detecting unit 319. Note that, in the drawing, the portions corresponding to those in FIG. 9 are denoted with reference numerals of which the lower two digits are the same, and with regard to the portions of which the processing is the same, description thereof will be redundant, and accordingly omitted.

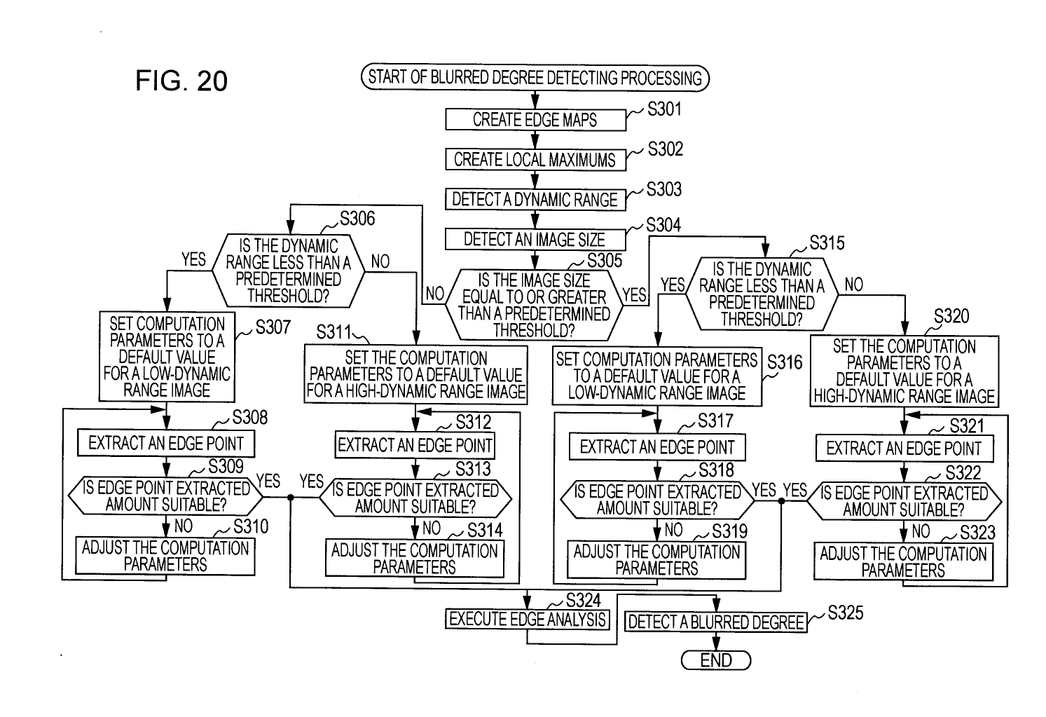

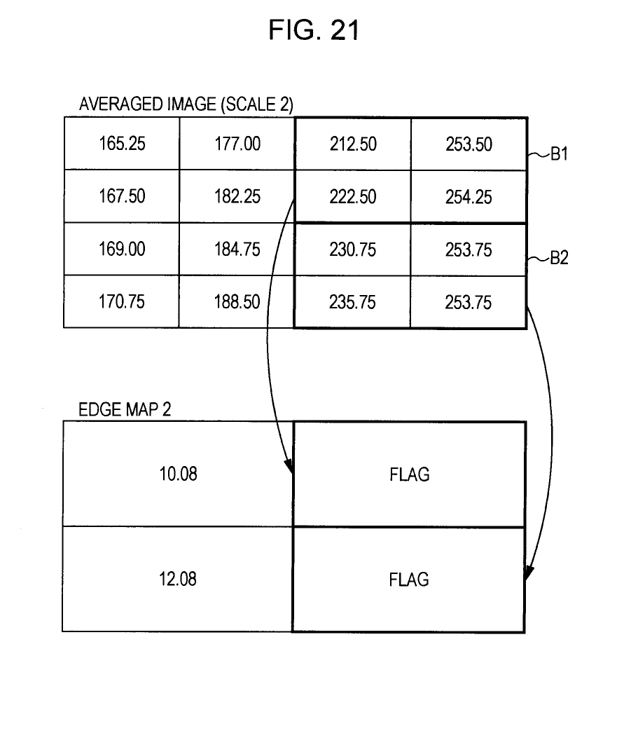

The edge map creating unit 311 differs in the creating method of the edge map 2 as compared to the edge map creating unit 11 in FIG. 1, the edge map creating unit 111 in FIG. 9, and the edge map creating unit 211 in FIG. 11. Note that description will be made later regarding this point with reference to FIGS. 20 and 21.

The edge points extracting unit 315 differs in the method for extracting edge points as compared to the edge points extracting unit 15 in FIG. 1, the edge points extracting unit 115 in FIG. 9, and the edge points extracting unit 215 in FIG. 11. Note that description will be made later regarding this point with reference to FIGS. 20 and 21.

### Description of Operation

Next, blurred degree detecting processing to be executed by the image processing apparatus 301 will be described with reference to the flowchart in FIG. 20. Note that this processing is started, for example, when an input image serving as a detected target is input to the edge maps creating unit 311 and the image size detecting unit 319.

In step S301, the edge map creating unit 311 creates edge maps. Note that, as described above, the edge map creating unit 311 differs in the creating method of the edge map 2 as compared to the edge map creating unit 11 in FIG. 1, the edge map creating unit 111 in FIG. 9, and the edge map creating unit 211 in FIG. 11.

Specifically, the edge map creating unit 311 sets the pixel value of the edge map 2 corresponding to the block of the averaged image of the scale 2 including a pixel of which the pixel value is equal to or greater than a predetermined threshold THw (e.g., 240) to a predetermined value FLAG. For example, in the case of considering the above image F2, such as shown in FIG. 21, the pixel value of the pixel of the edge map 2 corresponding to blocks B1 and B2 including a pixel of which the pixel value exceeds 240 with the averaged image of the scale 2 to the value FLAG.

Note that the calculation method for the pixel values of the edge map 2 corresponding to the block of the averaged image of the scale 2 not including a pixel of which the pixel value is equal to or greater than the predetermined threshold THw is the same as the above method. Also, the pixel value of the edge map 2 corresponding to a block not including a pixel of which the pixel value has to be less than the predetermined threshold Thw, and accordingly, the value FLAG may be a value equal to or greater than the predetermined threshold THw, and is set to 255 for example. Thus, with the edge map 2, a pixel to which the value FLAG is set, and a pixel other than that pixel, can be distinguished.

Note that the method for creating the edge maps 1 and 3 is the same as the above method, so redundant description thereof will be omitted.

The edge maps creating unit 311 supplies the created edge maps 1 through 3 to the dynamic range detecting unit 312 and the local maximums creating unit 314.

In step S302, the local maximums creating unit 314 creates local maximums 1 through 3 by the same processing as step S2 in FIG. 2, and supplies the created local maximums 1 through 3 to the edge pints extracting unit 315 and the edge analyzing unit 317.

At this time, as described above, the local maximum 2 is created by dividing the edge map 2 into blocks of 4×4 pixels, and extracting the maximum value of each block, and arraying the extracted maximum values in the same sequence as the corresponding block. Accordingly, the pixel value of the pixel of the local maximum 2 corresponding to a block including a pixel to which the value FLAG is set of the edge map 2 has to be set to the value FLAG. That is to say, the value FLAG is taken over from the edge map 2 to the local maximum 2.

Note that the local maximums 1 and 3 are the same as the local maximums 1 and 3 created in step S2 in FIG. 2.

Processing in steps S303 through S325 is the same as the above processing in steps S103 through S125 in FIG. 10 except for the processing in steps S308, S312, S317, so redundant description thereof will be omitted.

In step S308, the edge point extracting unit 315 extracts an edge point by the same processing as step S6 in FIG. 2. However, in the case that the pixel value of the local maximum 2 corresponding to the selected pixel of interest is set to the value FLAG, the edge points extracting unit 315 excludes, even if the pixel of interest thereof has been extracted as an edge point based on the local maximum 1 or 3, this edge point from the extracted edge points. Thus, a pixel of the input image included in a block where the pixel value is equal to or greater than the edge reference value with one of the local maximums 1 through 3, and also included in a block where the pixel value is less than THw with the averaged image of the scale 2, is extracted as an edge point.

In steps S312, S317, and S321 as well, an edge point is extracted in the same way as with the processing in step S308.

Accordingly, with the input image, a pixel included in a portion where over exposure occurs of which the pixel value is equal to or greater than a predetermined value is not extracted as an edge point. In other words, a pixel included in a block where the edge intensity is equal to or greater than the edge reference value, and also the pixel value is less than a predetermined value with the input image, is extracted as an edge point. As a result thereof, the over exposure of the input image can be prevented from affecting on the detection result of a blurred degree, and the blurred degree of the input image can be detected with higher precision.

### 8. Modification of Fourth Embodiment

Note that, with the above description, an example has been shown wherein the over exposure countermeasures are applied to the second embodiment of the image processing apparatus, but the over exposure countermeasures may be applied to the first and third embodiments.

Also, a pixel where under exposure occurs may be excluded from the edge points. This is realized, for example, by setting the pixel value of the pixel of the edge map 2 corresponding to the block of the averaged image of the scale 2 including a pixel of which the pixel value is equal or smaller than a threshold THb (e.g., 20 or less) to the value FLAG.

Further, a pixel where either over exposure or under exposure occurs may be excluded from the edge points. This is realized, for example, by setting the pixel value of the pixel of the edge map 2 corresponding to the block of the averaged image of the scale 2 including a pixel of which the pixel value is equal to or smaller than the threshold THb or equal to or greater than the threshold THw to the value FLAG.

Also, with not the edge map 2 but the edge map 1, processing for setting the pixel value to the value FLAG may be executed. Specifically, the pixel value of the edge map 1 corresponding to the block of the input image including a pixel of which the pixel value is equal to or greater than the threshold THw may be set to the value FLAG. In this case, as compared to a case of the edge map 2 being subjected to the processing, a pixel where over exposure occurs can accurately be excluded from the edge points, and accordingly, the detection precision of the blurred degree BlurEstimation improves, but on the other hand, processing time is delayed.

Further, with not the edge map 2 but the edge map 3, processing for setting the pixel value to the value FLAG may be executed. Specifically, the pixel value of the edge map 3 corresponding to the block of the averaged image of the scale 3 including a pixel of which the pixel value is equal to or greater than the threshold THw may be set to the value FLAG. In this case, as compared to a case of the edge map 2 being subjected to the processing, processing time is accelerated, but on the other hand, precision for eliminating a pixel where over exposure occurs from the edge points deteriorates, and the detection precision of the blurred degree BlurEstimation deteriorates.

### 9. Fifth Embodiment

Next, a fifth embodiment of the present invention will be described with reference to FIGS. 22 through 27. Note that, with the fifth embodiment of the present invention, learning of the parameters used for the above blurred degree detecting processing is executed.

### Functional Configuration Example of Learning Apparatus

FIG. 22 is a block diagram illustrating an embodiment of a learning apparatus to which the present invention has been applied. A learning apparatus 501 in FIG. 22 is an apparatus for learning an optimal combination of the threshold used for determination of a dynamic range (hereafter, referred to as “dynamic range determining value”), the edge reference value, and the extracted reference value, which are used with the image processing apparatus 1 in FIG. 1.

The learning apparatus 501 is configured so as to include a tutor data obtaining unit 511, a parameters supplying unit 512, an image processing unit 513, a learned data generating unit 514, and a parameters extracting unit 515. Also, the image processing unit 513 is configured so as to include an edge maps creating unit 521, a dynamic range detecting unit 522, an image classifying unit 523, a local maximums creating unit 524, an edge points extracting unit 525, an extracted amount determining unit 526, an edge analyzing unit 527, a blurred degree detecting unit 528, and an image determining unit 529.

The tutor data obtaining unit 511 obtains tutor data to be input externally. Here, the tutor data includes a tutor image serving as a learning processing target, and correct answer data indicating whether or not the tutor image thereof blurs. The correct answer data indicates, for example, whether or not the tutor image is a blurred image, and is obtained from results determined by a user actually viewing the tutor image, or from results analyzed by predetermined image processing, or the like. Note that an image that is not a blurred image will be referred to as a sharp image.

The tutor data obtaining unit 511 supplies the tutor image included in the tutor data to the edge maps creating unit 521. Also, the tutor data obtaining unit 511 supplies the correct answer data included in the tutor data to the learned data generating unit 514.

The parameters supplying unit 512 selects a combination of multiple parameters made up of the dynamic range determining value, edge reference value, and extracted reference value based on the values of a variable i and a variable j notified from the learned data generating unit 514. Of the selected parameters, the parameters supplying unit 512 notifies the image classifying unit 523 of the dynamic range determining value, notifies the edge points extracting unit 525 and the edge analyzing unit 527 of the edge reference value, and notifies the extracted amount determining unit 526 of the extracted reference value.

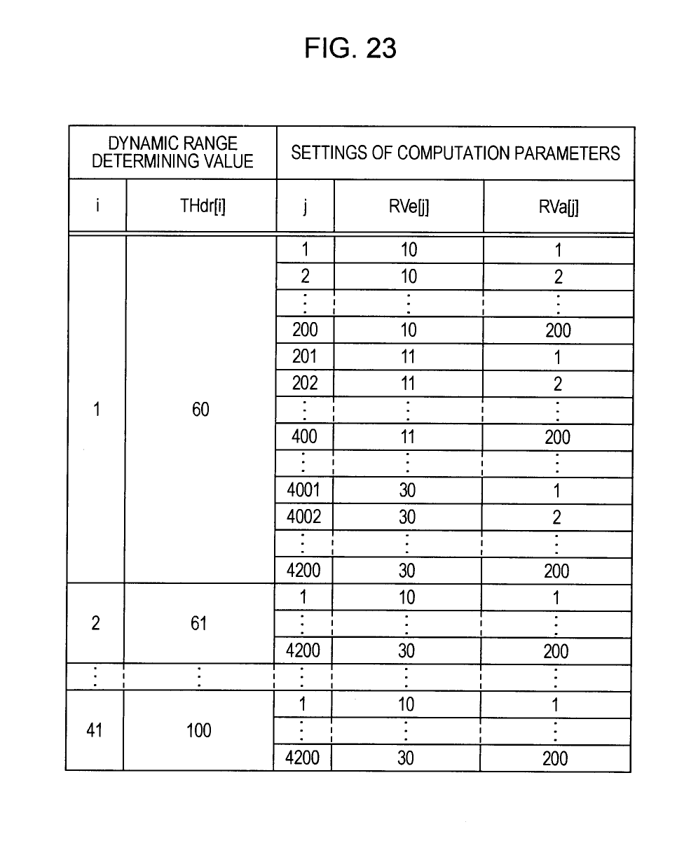

FIG. 23 illustrates a combination example of the parameters supplied from the parameters supplying unit 512. With this example, a dynamic range determining value THdr[i] takes 41 types of value from 60 to 100, an edge reference value RVe[j] takes 21 types of value from 10 to 30, and an extracted reference value RVa[j] takes 200 types of value from 1 to 200. Accordingly, a combination of the parameters is 41×21×200=172,200 types.

For example, in the case that i=1 and j=1 are notified from the learned data generating unit 514, the parameters supplying unit 512 selects a combination of the dynamic range determining value THdr[1]=60, edge reference value RVe[1]=10, and extracted reference value RVa[1]=1. Subsequently, the parameters supplying unit 512 notifies the image classifying unit 523 of the dynamic range determining value THdr[1], notifies the edge points extracting unit 525 and the edge analyzing unit 527 of the edge reference value RVe[1], and notifies the extracted amount determining unit 526 of the extracted reference value RVa[1].

The image processing unit 513 classifies the tutor image into either a high-dynamic range image or a low-dynamic range image based on the dynamic range determining value THdr[i] supplied from the parameters supplying unit 512. The image processing unit 513 notifies the learned data generating unit 514 of the classified result. Also, the image processing unit 513 determines whether the tutor image is a blurred image or a sharp image based on the edge reference value RVe[j] and extracted reference value RVa[j] supplied from the parameters supplying unit 512. The image processing unit 513 notifies the learned data generating unit 514 of the determined result.

More specifically, the edge maps creating unit 521 of the image processing unit 513 has the same function as the edge maps creating unit 11 in FIG. 1, and creates edge maps 1 through 3 from the given tutor image. The edge maps creating unit 521 supplies the created edge maps 1 through 3 to the dynamic range detecting unit 522 and the local maximums creating unit 524.

The dynamic range detecting unit 522 has the same function as the dynamic range detecting unit 12 in FIG. 1, and detects the dynamic range of the tutor image. The dynamic range detecting unit 522 supplies information indicating the detected dynamic range to the image classifying unit 523.

The image classifying unit 523 classifies the tutor image into either a high-dynamic range image or a low-dynamic range image based on the dynamic range determining value THdr[i] supplied from the parameters supplying unit 512. The image classifying unit 523 notifies the learned data generating unit 514 of the classified result.

The local maximums creating unit 524 has the same function as with the local maximums creating unit 14 in FIG. 1, and creates local maximums 1 through 3 based on the edge maps 1 through 3. The local maximums creating unit 524 supplies the created local maximums 1 through 3 to the edge points extracting unit 525 and the edge analyzing unit 527.

The edge points extracting unit 525 has the same function as with the edge points extracting unit 15 in FIG. 1, and extracts an edge point from the tutor image based on the edge reference value RVe[j] supplied from the parameters supplying unit 512, and the local maximums 1 through 3. Also, the edge points extracting unit 525 creates edge point tables 1 through 3 indicating information of the extracted edge points. The edge points extracting unit 525 supplies the created edge point tables 1 through 3 to the extracted amount determining unit 526.

The extracted amount determining unit 526 has the same function as with the extracted amount determining unit 16 in FIG. 1, and determines whether or not the edge point extracted amount is suitable based on the extracted reference value RVa[j] supplied from the parameters supplying unit 512. In the case that determination is made that the edge point extracted amount is suitable, the extracted amount determining unit 526 supplies the edge point tables 1 through 3 to the edge analyzing unit 527. Also, in the case that determination is made that the edge point extracted amount is not suitable, the extracted amount determining unit 526 notifies the learned data generating unit 514 that the edge point extracted amount is not suitable.

The edge analyzing unit 527 has the same function as with the edge analyzing unit 17 in FIG. 1, and analyzes the edge points of the tutor image based on the edge point tables 1 through 3, local maximums 1 through 3, and edge reference value RVe[j]. The edge analyzing unit 527 supplies information indicating the analysis results to the blurred degree detecting unit 528.

The blurred degree detecting unit 528 has the same function as with the blurred degree detecting unit 18 in FIG. 1, and detects the blurred degree of the tutor image based on the analysis results of the edge points. The blurred degree detecting unit 528 supplies information indicating the detected blurred degree to the image determining unit 529.

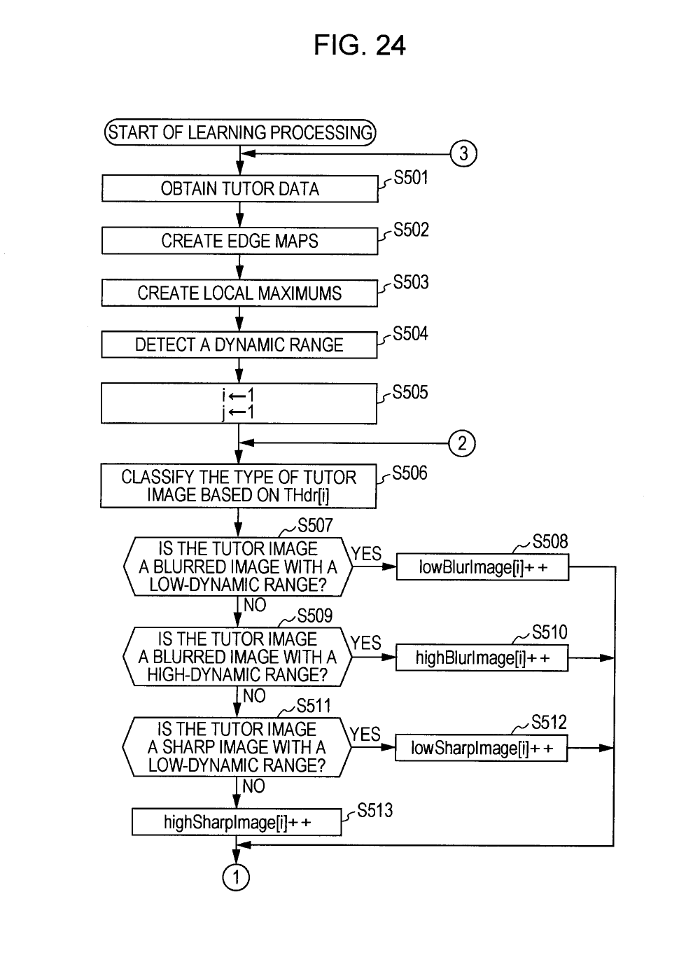

The image determining unit 529 executes, such as described later with reference to FIGS. 24 through 26, the blur determination of the tutor image based on the blurred degree detected by the blurred degree detecting unit 528. That is to say, the image determining unit 529 determines whether the tutor image is either a blurred image or a sharp image. The image determining unit 529 supplies information indicating the determined result to the learned data generating unit 514.

The learned data generating unit 514 generates, such as described later with reference to FIGS. 24 through 26, learned data based on the classified results of the tutor image by the image classifying unit 523, and the determined result by the image determining unit 529. The learned data generating unit 514 supplies information indicating the generated learned data to the parameters extracting unit 515. Also, the learned data generating unit 514 instructs the tutor data obtaining unit 511 to obtain the tutor data.

The parameters extracting unit 515 extracts, such as described later with reference to FIGS. 24 through 27, a combination most suitable for detection of the blurred degree of the image, of a combination of the parameters supplied from the parameters supplying unit 512. The parameters extracting unit 515 supplies information indicating the extracted combination of the parameters to an external device such as the image processing apparatus 1 in FIG. 1.

### Description of Operation

Next, learning processing to be executed by the learning apparatus 501 will be described with reference to the flowchart in FIGS. 24 through 26. Note that this processing is started, for example, when the start command of the learning processing is input to the learning apparatus 501 via an operating unit not shown in the drawing.

In step S501, the tutor data obtaining unit 511 obtains tutor data. The tutor data obtaining unit 511 supplies the tutor image included in the obtained tutor data to the edge maps creating unit 521. Also, the tutor data obtaining unit 511 supplies the correct answer data included in the tutor data to the learned data generating unit 514.

In step S502, the edge maps creating unit 521 creates edge maps 1 through 3 as to the tutor image by the same processing as step S1 in FIG. 2. The edge maps creating unit 521 supplies the created edge maps 1 through 3 to the dynamic range detecting unit 522 and the local maximums creating unit 524.

In step S503, the local maximums creating unit 524 creates local maximums 1 through 3 as to the tutor image by the same processing as step S2 in FIG. 2. The local maximums creating unit 524 supplies the created local maximums 1 through 3 to the edge points extracting unit 525 and the edge analyzing unit 527.

In step S504, the dynamic range detecting unit 522 detects the dynamic range of the tutor image by the same processing as step S3 in FIG. 2. The dynamic range detecting unit 522 supplies information indicating the detected dynamic range to the image classifying unit 523.

In step S505, the learned data generating unit 514 sets the value of a variable i to 1, and sets the value of a variable j to 1. The learned data generating unit 514 notifies the set values of the variables i and j to the parameters supplying unit 512. The parameters supplying unit 512 notifies the image classifying unit 523 of the dynamic range determining value THdr[i] (in this case, THdr[1]). Also, the parameters supplying unit 512 notifies the edge points extracting unit 525 and the edge analyzing unit 527 of the edge reference value RVe[j] (in this case, RVe[1]). Further, the parameters supplying unit 512 notifies the extracted amount determining unit 526 of the extracted reference value RVa[j] (in this case, RVa[1]).

In step S506, the image classifying unit 523 classifies the type of the tutor image based on the dynamic range determining value THdr[i]. Specifically, in the case that the dynamic range of the tutor image <THdr[i] holds, the image classifying unit 523 classifies the tutor image into a low-dynamic range image. Also, in the case that the dynamic range of the tutor image≧THdr[i] holds, the image classifying unit 523 classifies the tutor image into a high-dynamic range image. The image classifying unit 523 notifies the learned data generating unit 514 of the classified result.

In step S507, the learned data generating unit 514 determines whether or not the tutor image is a low-dynamic range blurred image based on the classified result by the image classifying unit 523 and the correct answer data. In the case that the tutor image is determined to be a low-dynamic range blurred image, the flow proceeds to step S508.

In step S508, the learned data generating unit 514 increments the value of a variable lowBlurImage[i] by one. Note that the variable lowBlurImage[i] is a variable for counting the number of tutor images classified into a low-dynamic range blurred image based on the dynamic range determining value THdr[i] and the correct answer data. Subsequently, the flow proceeds to step S514.

On the other hand, in the case that the tutor image is determined not to be a low-dynamic range blurred image in step S507, the flow proceeds to step S509.

In step S509, the learned data generating unit 514 determines whether or not the tutor image is a high-dynamic range blurred image based on the classified result by the image classifying unit 523 and the correct answer data. In the case that the tutor image is determined to be a high-dynamic range blurred image, the flow proceeds to step S510.

In step S510, the learned data generating unit 514 increments the value of a variable highBlurImage[i] by one. Note that the variable highBlurImage[i] is a variable for counting the number of tutor images classified into a high-dynamic range blurred image based on the dynamic range determining value THdr[i] and the correct answer data. Subsequently, the flow proceeds to step S514.

On the other hand, in the case that the tutor image is determined not to be a high-dynamic range blurred image in step S509, the flow proceeds to step S511.

In step S511, the learned data generating unit 514 determines whether or not the tutor image is a low-dynamic range sharp image based on the classified result by the image classifying unit 523 and the correct answer data. In the case that the tutor image is determined to be a low-dynamic range sharp image, the flow proceeds to step S512.

In step S512, the learned data generating unit 514 increments the value of a variable lowSharpImage[i] by one. Note that the variable lowSharpImage[i] is a variable for counting the number of tutor images classified into a low-dynamic range sharp image based on the dynamic range determining value THdr[i] and the correct answer data. Subsequently, the flow proceeds to step S514.

On the other hand, in the case that determination is made in step S511 that the tutor image is not a low-dynamic range sharp image, i.e., in the case that the tutor image is a high-dynamic range sharp image, the flow proceeds to step S513.

In step S513, the learned data generating unit 514 increments the value of a variable highSharpImage[i] by one. Note that the variable highSharpImage[i] is a variable for counting the number of tutor images classified into a high-dynamic range sharp image based on the dynamic range determining value THdr[i] and the correct answer data. Subsequently, the flow proceeds to step S514.

In step S514, the edge points extracting unit 525 extracts an edge point by the same processing as step S6 in FIG. 2 based on the edge reference value RVe[j] and the local maximums 1 through 3, and creates edge point tables 1 through 3. The edge points extracting unit 525 supplies the created edge point tables 1 through 3 to the extracted amount determining unit 526.

In step S515, the extracted amount determining unit 526 determines whether or not the edge point extracted amount is suitable. In the case of the edge point extracted amount the extracted reference value RVa[j], the extracted amount determining unit 526 determines that the edge point extracted amount is suitable, and the flow proceeds to step S516.

In step S516, the edge analyzing unit 527 executes edge analysis. Specifically, the extracted amount determining unit 526 supplies the edge point tables 1 through 3 to the edge analyzing unit 527. The edge analyzing unit 527 executes, in the same way as with the processing in step S13 in FIG. 2, the edge analysis of the tutor image based on the edge point tables 1 through 3, local maximums 1 through 3, and edge reference value RVe[j]. The edge analyzing unit 527 supplies information indicating N_{smallblur} and N_{largeblur} calculated by the edge analysis to the blurred degree detecting unit 528.

In step S517, the blurred degree detecting unit 528 calculates a blurred degree BlurEstimation in the same way as with the processing in step S14 in FIG. 2. The blurred degree detecting unit 528 supplies information indicating the calculated blurred degree BlurEstimation to the image determining unit 529.

In step S518, the image determining unit 529 executes blur determination. Specifically, the image determining unit 529 compares the blurred degree BlurEstimation and a predetermined threshold. Subsequently, in the case that the blurred degree BlurEstimation the predetermined threshold holds, the image determining unit 529 determines that the tutor image is a blurred image, and in the case that the blurred degree BlurEstimation <the predetermined threshold holds, the image determining unit 529 determines that the tutor image is a sharp image. The image determining unit 529 supplies information indicating the determined result to the learned data generating unit 514.

In step S519, the learned data generating unit 514 determines whether or not the determined result is correct. In the case that the determined result by the image determining unit 529 matches the correct answer data, the learned data generating unit 514 determines that the determined result is correct, and the flow proceeds to step S520.

In step S520, in the same way as with the processing in step S507, determination is made whether or not the tutor image is a low-dynamic range blurred image. In the case that the tutor image is determined to be a low-dynamic range blurred image, the flow proceeds to step S521.

In step S521, the learned data generating unit 514 increments the value of a variable lowBlurCount[i][j] by one. Note that the variable lowBlurCount[i][j] is a variable for counting the number of tutor images classified into a low-dynamic range image based on the dynamic range determining value THdr[i], and determined to be a correct blurred image based on the edge reference value RVe[j] and the extracted reference value RVa[j]. Subsequently, the flow proceeds to step S527.

On the other hand, in the case that the tutor image is determined not to be a low-dynamic range blurred image in step S520, the flow proceeds to step S522.

In step S522, in the same way as with the processing in step S509, determination is made whether or not the tutor image is a high-dynamic range blurred image. In the case that the tutor image is determined to be a high-dynamic range blurred image, the flow proceeds to step S523.

In step S523, the learned data generating unit 514 increments the value of a variable highBlurCount[i][j] by one. Note that the variable highBlurCount[i][j] is a variable for counting the number of tutor images classified into a high-dynamic range image based on the dynamic range determining value THdr[i], and determined to be a correct blurred image based on the edge reference value RVe[j] and the extracted reference value RVa[j]. Subsequently, the flow proceeds to step S527.

On the other hand, in the case that the tutor image is determined not to be a high-dynamic range blurred image in step S522, the flow proceeds to step S524.

In step S524, in the same way as with the processing in step S511, determination is made whether or not the tutor image is a low-dynamic range sharp image. In the case that the tutor image is determined to be a low-dynamic range sharp image, the flow proceeds to step S525.

In step S525, the learned data generating unit 514 increments the value of a variable lowSharpCount[i][j] by one. Note that the variable lowSharpCount[i][j] is a variable for counting the number of tutor images classified into a low-dynamic range image based on the dynamic range determining value THdr[i], and determined to be a correct sharp image based on the edge reference value RVe[j] and the extracted reference value RVa[j]. Subsequently, the flow proceeds to step S527.

On the other hand, in the case that the tutor image is determined not to be a low-dynamic range sharp image in step S524, the flow proceeds to step S526.

In step S526, the learned data generating unit 514 increments the value of a variable highSharpCount[i][j] by one. Note that the variable highSharpCount[i][j] is a variable for counting the number of tutor images classified into a high-dynamic range image based on the dynamic range determining value THdr[i], and determined to be a correct sharp image based on the edge reference value RVe[j] and the extracted reference value RVa[j]. Subsequently, the flow proceeds to step S527.

On the other hand, in step S519, in the case that the determined result by the image determining unit 529 does not match the correct answer data, the learned data generating unit 514 determines that the determined result is wrong. Subsequently, the processing in steps S520 through S526 is skipped, and the flow proceeds to step S527.

Also, in step S515, in the case that the edge point extracted amount<the extracted reference value RVa[j] holds, the extracted amount determining unit 526 determines that the edge point extracted amount is not suitable. Subsequently, the processing in steps S516 through S526 is skipped, and the flow proceeds to step S527.

In step S527, the learned data generating unit 514 determines whether or not the variable j<JMAX holds. In the case that determination is made that the variable j<JMAX holds, the flow proceeds to step S528. Note that, for example, in the case that the above combination of the parameters in FIG. 23 is used, the value of JMAX is 4200.

In step S528, the learned data generating unit 514 increments the value of the variable j by one. The learned data generating unit 514 notifies the parameters supplying unit 512 of the current values of the variables i and j. The parameters supplying unit 512 notifies the image classifying unit 523 of the dynamic range determining value THdr[i]. Also, the parameters supplying unit 512 notifies the edge points extracting unit 525 and the edge analyzing unit 527 of the edge reference value RVe[j]. Further, the parameters supplying unit 512 notifies the extracted amount determining unit 526 of the extracted reference value RVa[j].

Subsequently, the flow returns to step S514, where the processing in steps S514 through S528 is repeatedly executed until determination is made in step S527 that the variable j≧JMAX holds.

On the other hand, in the case that determination is made in step S527 that the variable j≧JMAX holds, the flow proceeds to step S529.

In step S529, the learned data generating unit 514 determines whether or not the variable i<IMAX holds. In the case that determination is made that the variable i<IMAX holds, the flow proceeds to step S530. Note that, for example, in the case that the above combination of the parameters in FIG. 23 is used, the value of IMAX is 41.

In step S530, the learned data generating unit 514 increments the value of the variable i by one, and the value of the variable j is set to 1. The learned data generating unit 514 notifies the parameters supplying unit 512 of the current values of the variables i and j. The parameters supplying unit 512 notifies the image classifying unit 523 of the dynamic range determining value THdr[i]. Also, the parameters supplying unit 512 notifies the edge points extracting unit 525 and the edge analyzing unit 527 of the edge reference value RVe[j]. Further, the parameters supplying unit 512 notifies the extracted amount determining unit 526 of the extracted reference value RVa[j].

Subsequently, the flow returns to step S506, where the processing in steps S506 through S530 is repeatedly executed until determination is made that the variable i≧IMAX holds.

On the other hand, in the case that determination is made in step S530 that the variable i≧IMAX holds, the flow proceeds to step S531.

In step S531, the learned data generating unit 514 determines whether or not learning has been done regarding a predetermined number of tutor images. In the case that determination is made that learning has not been done regarding a predetermined number of tutor images, the learned data generating unit 514 instructs the tutor data obtaining unit 511 to obtain tutor data. Subsequently, the flow returns to step S501, where the processing in steps S501 through S531 is repeatedly executed until determination is made in step S531 that learning has been done regarding a predetermined number of tutor images.

Thus, the determined results of blur determination as to a predetermined number of tutor images are obtained in the case of using each combination of the dynamic range determining value THdr[i], edge reference value RVe[j], and extracted reference value RVa[j], and are stored as learned data.

On the other hand, in the case that determination is made in step S531 that learning has been done regarding a predetermined number of tutor images, the learned data generating unit 514 supplies the values of the variables lowBlurImage[i], highBlurImage[i], lowSharpImage[i], highSharpImage[i], lowBlurCount[i][j], highBlurCount[i][j], lowSharpCount[i][j], and highSharpCount[i][j] to the parameters extracting unit 515 as learned data. Subsequently, the flow proceeds to step S532.

In step S532, the parameters extracting unit 515 sets the value of the variable i to 1, and sets the value of the variable j to 1.

In step S533, the parameters extracting unit 515 initializes the values of variables MinhighCV, MinlowCV, highJ, and lowJ. That is to say, the parameters extracting unit 515 sets the values of the variables MinhighCV and MinlowCV to a value greater than the maximum value that later-described highCV and lowCV can take. Also, the parameters extracting unit 515 sets the values of the variables highJ and lowJ to 0.

In step S534, the parameters extracting unit 515 calculates highSharp, lowSharp, highBlur, and lowBlur based on the following Expressions (17) through (20)

$$\begin{matrix}highSharp = 1 - \frac{highSharpCount [ i ] [ j ]}{highSharpImage [ i ]} & ( 17 ) \\ lowSharp = 1 - \frac{lowSharpCount [ i ] [ j ]}{lowSharpImage [ i ]} & ( 18 ) \\ highBlur = \frac{highBlurCount [ i ] [ j ]}{highBlurImage [ i ]} & ( 19 ) \\ lowBlur = \frac{lowBlurCount [ i ] [ j ]}{lowBlurImage [ i ]} & ( 20 )\end{matrix}$$

where highSharp represents the percentage of sharp images erroneously determined to be a blur image based on the edge reference value RVe[j] and the extracted reference value RVa[j], of sharp images classified into a high dynamic range based on the dynamic range determining value THdr[i]. That is to say, highSharp represents probability wherein a high-dynamic range sharp image is erroneously determined to be a blurred image in the case of using the dynamic range determining value THdr[i], edge reference value RVe[j], and extracted reference value RVa[j]. Similarly, lowSharp represents probability wherein a low-dynamic range sharp image is erroneously determined to be a blurred image in the case of using the dynamic range determining value THdr[i], edge reference value RVe[j], and extracted reference value RVa[j].

Also, highBlur represents the percentage of blurred images correctly determined to be a blur image based on the edge reference value RVe[j] and the extracted reference value RVa[j], of blurred images classified into a high dynamic range based on the dynamic range determining value THdr[i]. That is to say, highBlur represents probability wherein a high-dynamic range blurred image is correctly determined to be a blurred image in the case of using the dynamic range determining value THdr[i], edge reference value RVe[j], and extracted reference value RVa[j]. Similarly, lowBlur represents probability wherein a low-dynamic range blurred image is correctly determined to be a blurred image in the case of using the dynamic range determining value THdr[i], edge reference value RVe[j], and extracted reference value RVa[j].

In step S535, the parameters extracting unit 515 calculates highCV and lowCV based on the following Expressions (21) and (22)

highCV=\sqrt{highSharp²+(1−highBlur)²} (21)

lowCV=\sqrt{lowSharp²+(1−lowBlur)²} (22)

where highCV represents distance between coordinates (0, 1) and coordinates (x1, y1) of a coordinate system with the x axis as highSharp and with the y axis as highBlur, in the case that the value of highSharp is taken as x1, and the value of highBlur is taken as y1, obtained in step S534. Accordingly, the higher the precision of blur determination as to a high-dynamic range image is, the smaller the value of highCV is, and the lower the precision of blur determination as to a high-dynamic range image is, the greater the value of highCV is.

Similarly, lowCV represents distance between coordinates (0, 1) and coordinates (x2, y2) of a coordinate system with the x axis as lowSharp and with the y axis as lowBlur, in the case that the value of lowSharp is taken as x2, and the value of lowBlur is taken as y2, obtained in step S534. Accordingly, the higher the precision of blur determination as to a low-dynamic range image is, the smaller the value of lowCV is, and the lower the precision of blur determination as to a low-dynamic range image is, the greater the value of lowCV is.

In step S536, the parameters extracting unit 515 determines whether or not highCV <MinhighCV holds. In the case that determination is made that highCV<MinhighCV holds, i.e., in the case that highCV obtained this time is the minimum value so far, the flow proceeds to step S537.

In step S537, the parameters extracting unit 515 sets the variable highJ to the current value of the variable j, and sets the variable MinhighCV to the value of highCV obtained this time. Subsequently, the flow proceeds to step S538.

On the other hand, in the case that determination is made in step S536 that highCV MinhighCV holds, the processing in step S537 is skipped, and the flow proceeds to step S538.

In step S538, the parameters extracting unit 515 determines whether or not lowCV<MinlowCV holds. In the case that determination is made that lowCV<MinlowCV holds, i.e., in the case that lowCV obtained this time is the minimum value so far, the flow proceeds to step S539.

In step S539, the parameters extracting unit 515 sets the variable lowJ to the current value of the variable j, and sets the variable MinlowCV to the value of lowCV obtained this time. Subsequently, the flow proceeds to step S540.

On the other hand, in the case that determination is made in step S538 that lowCV MinlowCV holds, the processing in step S539 is skipped, and the flow proceeds to step S540.

In step S540, the parameters extracting unit 515 determines whether or not the variable j<JMAX holds. In the case that determination is made that j<JMAX holds, the flow proceeds to step S541.

In step S541, the parameters extracting unit 515 increments the value of the variable j by one.

Subsequently, in step S540, the flow returns to step S534, where the processing in steps S534 through S541 is repeatedly executed until determination is made that the variable j≧JMAX holds. Thus, highCV and lowCV as to each combination of the edger reference value RVe[j] and the extracted reference value RVa[j] (j=1 through JMAX) in the case that the dynamic range determining value is THdr[i] (in this case, THdr[1]) are calculated. Also, the value of the variable j when highCV becomes the minimum is stored in the variable highJ, and the value of the variable j when lowCV becomes the minimum is stored in the variable lowJ.

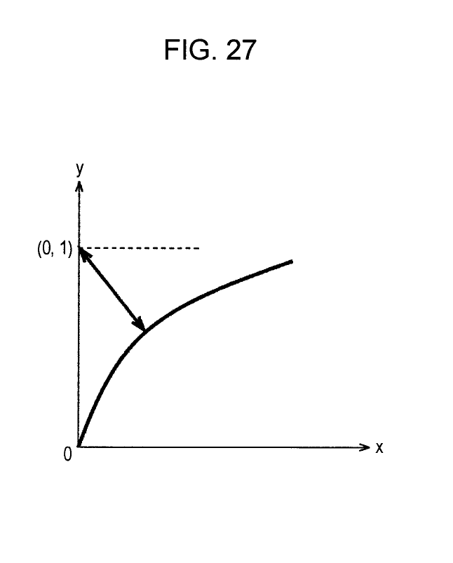

FIG. 27 illustrates an example of a ROC (Receiver Operating Characteristic) curve to be drawn by plotting values of (highSharp, highBlur) obtained as to each combination of the edge reference value RVe[j] and the extracted reference value RVa[j] regarding one dynamic range determining value THdr[i]. Note that the x axis of this coordinate system represents highSharp, and the y axis represents highBlur.

With this ROC curve, the combination between the edge reference value and the extracted reference value corresponding to a point where distance from the coordinates (0, 1) becomes the minimum are the edge reference value RVe[highJ] and the extracted reference value RVa[highJ]. That is to say, in the case that the dynamic range determining value is set to THdr[i], when using the combination between the edge reference value RVe[highJ] and the extracted reference value RVa[highJ], the precision of blur determination as to a high-dynamic range image becomes the highest.

Similarly, in the case that the dynamic range determining value is set to THdr[i], when using the combination between the edge reference value RVe[lowJ] and the extracted reference value RVa[lowJ], the precision of blur determination as to a low-dynamic range image becomes the highest.

On the other hand, in the case that determination is made in step S540 that the variable j≧JMAX holds, the flow proceeds to step S542.

In step S542, the parameters extracting unit 515 calculates CostValue[i] based on the following Expression (23).

$$CostValue [ i ] = \frac{\begin{matrix}highSharpCount [ i ] [ highJ ] + \\ lowSharpCount [ i ] [ lowJ ]\end{matrix}}{highSharpImage [ i ] + lowSharpImage [ i ]} + \frac{\begin{matrix}highBlurCount [ i ] [ highJ ] + \\ lowBlurCount [ i ] [ lowJ ]\end{matrix}}{highBlurImage [ i ] + lowBlurImage [ i ]} \qquad ( 23 )$$

The first term of the right side of Expression (23) represents probability wherein a sharp image is correctly determined to be a sharp image in the case of using the combination of the dynamic range determining value THdr[i], edge reference value RVe[highJ], extracted reference value RVa[highJ], edge reference value RVe[lowJ], and extracted reference value RVa[lowJ]. Also, the second term of the right side of Expression (23) represents probability wherein a blurred image is correctly determined to be a blurred image in the case of using the combination of the dynamic range determining value THdr[i], edge reference value RVe[highJ], extracted reference value RVa[highJ], edge reference value RVe[lowJ], and extracted reference value RVa[lowJ].

Specifically, CostValue[i] represents the precision of image blur determination in the case of using the combination of the dynamic range determining value THdr[i], edge reference value RVe[highJ], extracted reference value RVa[highJ], edge reference value RVe[lowJ], and extracted reference value RVa[lowJ]. More specifically, CostValue[i] uses the combination between the edge reference value RVe[highJ] and the extracted reference value RVa[highJ] to execute blur determination as to an image classified into a high-dynamic range with the dynamic range determining value THdr[i], and when using the combination between the edge reference value RVe[lowJ] and the extracted reference value RVa[lowJ] to execute blur determination as to an image classified into a low-dynamic range with the dynamic range determining value THdr[i], indicates the sum of probability for accurately determining a sharp image to be a sharp image, and probability for accurately determining a blurred image to be a blurred image. Accordingly, the maximum value of CostValue[i] is 2.

In step S543, the parameters extracting unit 515 sets the value of the variable highJ[i] to the current value of the variable highJ, and sets the value of the variable lowJ[i] to the current value of the variable lowJ.

In step S544, the parameters extracting unit 515 determines whether or not the variable i<IMAX holds. In the case that determination is made that the variable i<IMAX holds, the flow proceeds to step S545.

In step S545, the parameters extracting unit 515 increments the value of the variable i by one, and sets the value of the variable j to 1.

Subsequently, the flow returns to step S533, where the processing in steps S533 through S545 is repeatedly executed until determination is made in step S544 that the variable i≧IMAX holds. Thus, the combination between the edge reference value RVe[j] and the extracted reference value RVa[j] whereby highCV becomes the minimum as each dynamic range determining value THdr[i] from THdr[1] to THdr[IMAX], and the combination between the edge reference value RVe[j] and the extracted reference value RVa[j] whereby lowCV becomes the minimum are extracted. Also, CostValue[i] in the case of using the combination between the edge reference value RVe[j] and the extracted reference value RVa[j] extracted as to each dynamic range determining value THdr[i] is calculated.

On the other hand, in the case that determination is made in step S544 that the variable i≧IMAX holds, the flow proceeds to step S546.

In step S546, the parameters extracting unit 515 extracts the combination of parameters whereby CostValue[i] becomes the maximum. In other words, the parameters extracting unit 515 extracts the combination of parameters whereby the precision of image blur determination becomes the highest. Specifically, the parameters extracting unit 515 extracts the maximum value from CostValue[i] from CostValue[1] to CostValue[IMAX]. Also, in the case that the value of i whereby CostValue[i] becomes the maximum is taken as I, and highJ[I]=HJ and lowJ[I]=LJ are assumed, the parameters extracting unit 515 extracts the combination of the dynamic range determining value THdr[I], edge reference value RVe[HJ], extracted reference value RVa[HJ], edge reference value RVe[LJ], and extracted reference value RVa[LJ] as parameters used for the blurred degree detecting processing described above with reference to FIG. 2.

Subsequently, the dynamic range determining value THdr[I] is used as a threshold at the time of determining the dynamic range of the image at the processing in step S4 in FIG. 2. Also, the edge reference value RVe[LJ] and the extracted reference value RVa[LJ] are used as the default values of the computation parameters to be set at the processing in step S5. Further, the edge reference value RVe[HJ] and the extracted reference value RVa[HJ] are used as the default values the computation parameters to be set at the processing in step S9.

As described above, the default values of the dynamic range determining value, edge reference value, and extracted reference value to be used at the image processing apparatus 1 in FIG. 1 can be set to suitable values. Also, the default values of the edge reference value and the extracted reference value can be set to suitable values for each type of image classified by the dynamic range determining value. As a result thereof, the blurred degree of the input image can be detected with higher precision.

### 10. Modification of Fifth Embodiment

Note that an arrangement may be made wherein, according to the same processing, the type of an image is classified into three types or more based on the range of the dynamic range, and the suitable default values of the edge reference value and the extracted reference value are obtained for each image type.

Also, an arrangement may be made wherein the dynamic range determining value is fixed to a predetermined value without executing learning of the dynamic range determining value, only the default values of the edge reference value and the extracted reference value are obtained according to the same processing.

Further, this learning processing may also be applied to a case where the type of an image type is classified based on the feature amount of an image other than a dynamic range such as the above image size, location of shooting, or the like, and the default values of the edge reference value and the extracted reference value are set for each image type. For example, in the case of the type of an image is classified by the image size, with the combination of the parameters in FIG. 23, the determined value of the image size is used instead of the dynamic range determining value, whereby a suitable combination of the determined value of the image size, the edge reference value, and the extracted reference value can be obtained.

Also, similarly, this learning processing may also be applied to a case where the type of an image type is classified by combining multiple feature amounts (e.g., dynamic range and image size), and the default values of the edge reference value and the extracted reference value are set for each image type.

Further, for example, with regard to a computation parameter other than the edge reference value and the extracted reference value as well, such as the above threshold THw of over exposure countermeasures, or the like, a suitable value can be obtained according to the same learning processing. This can be realized, for example, by adding a computation parameter item to be obtained to a set of computation parameters with the combination of the parameters in FIG. 23 to execute learning processing.

Also, with the above description, an example has been shown wherein, with the learning apparatus 501, edge maps are created from a tutor image, but an arrangement may be made wherein an edge map as to a tutor image is created at an external device, and the edge map is included in tutor data. Similarly, an arrangement may be made wherein a local maximum as to a tutor image is created at an external device, and the local maximum is included in tutor data.

The above-mentioned series of processing can be executed by hardware, and can also be executed by software. In the case of executing the series of processing by software, a program making up the software thereof is installed from a program recording medium to a computer embedded in dedicated hardware, or a device capable of executing various types of functions by various types of programs being installed, such as a general-purpose personal computer for example.

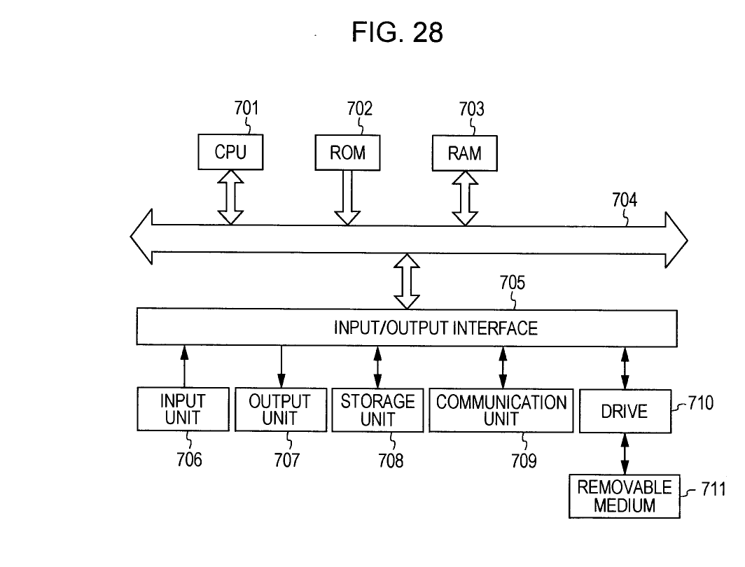

FIG. 28 is a block diagram illustrating a configuration example of the hardware of a computer for executing the above series of processing by the program.

With the computer, a CPU (Central Processing Unit) 701, ROM (Read Only Memory) 702, and RAM (Random Access Memory) 703 are connected mutually with a bus 704.

Further, an input/output interface 705 is connected to the bus 704. An input unit 706 made up of a keyboard, mouse, microphone, or the like, an output unit 707 made up of a display, speaker, or the like, a storage unit 708 made up of a hard disk, nonvolatile memory, or the like, a communication unit 709 made up of a network interface or the like, and a drive 710 for driving a removable medium 711 such as a magnetic disk, optical disk, magneto-optical disk, or semiconductor memory are connected to the input/output interface 705.

With the computer thus configured, the above series of processing is executed by the CPU 701 loading, for example, a program stored in the recording unit 708 to the RAM 703 via the input/output interface 705 and the bus 704, and executing this.

The program to be executed by the computer (CPU 701) is provided, for example, by being recorded in the removable medium 711 that is a packaged medium made up of a magnetic disk (including flexible disks), optical disc (CD-ROM (Compact Disc-Read Only Memory), DVD (Digital Versatile Disc), etc.), magneto-optical disk, semiconductor memory, or the like, or via a cable or wireless transmission medium such as a local network, Internet, or digital satellite broadcasting.

The program can be installed into the storage unit 708 via the input/output interface 705 by the removable medium 711 being mounted on the drive 710. Also, the program can be received at the communication unit 709 via a cable or wireless transmission medium, and can be installed into the storage unit 708. In addition, the program can be installed into the ROM 702 or storage unit 708 beforehand.

Note that the program to be executed by the computer may be a program wherein processing is executed in time-sequence in accordance with the sequence described in the present Specification, or may be a program to be executed in parallel, or at suitable timing when calling is executed or the like,

Also, the embodiments of the present invention are not restricted to the above embodiments, and various modifications can be performed without departing from the essence of the present invention.

The present application contains subject matter related to that disclosed in Japanese Priority Patent Application JP 2009-060620 filed in the Japan Patent Office on Mar. 13, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
edge intensity detecting means configured to detect the edge intensity of an image in increments of blocks having a predetermined size;
parameter setting means configured to set an edge reference value used for extraction of an edge point that is a pixel used for detection of the blurred degree of said image based on a dynamic range that is difference between the maximum value and the minimum value of said edge intensities; and
edge point extracting means configured to extract a pixel as said edge point with said edge intensity being equal to or greater than said edge reference value, and also the pixel value of a pixel within a block being included in an edge block that is a block within a predetermined range.

2. The image processing apparatus according to claim 1, wherein said edge intensity detecting means detect said edge intensity of said image in increments of first blocks having a first size, and further detect said edge intensity of said image in increments of second blocks having a second size different from said first size by detecting said edge intensity of a first averaged image made up of the average value of pixels within each block obtained by dividing said image into blocks having said first size in increments of blocks having said first size, and further detect said edge intensity of said image in increments of third blocks having a third size different from said first size and said second size by detecting said edge intensity of a second averaged image made up of the average value of pixels within each block obtained by dividing said first averaged image into blocks having said first size in increments of blocks having said first size;
and wherein said edge point extracting means extract a pixel as said edge point with said edge intensity being included in one of said first through third blocks of which said edge intensity is equal to or greater than said edge reference value, and also the pixel value of said first averaged image being included in a block within a predetermined range.

3. The image processing apparatus according to claim 1, wherein said parameter setting means further set an extracted reference value used for determination regarding whether or not the extracted amount of said edge point is suitable based on the dynamic range of said image, and also adjust said edge reference value so that the extracted amount of said edge point becomes suitable amount as compared to said extracted reference value.

4. The image processing apparatus according to claim 1, further comprising:
analyzing means configured to analyze whether or not blur occurs at said extracted edge point; and
blurred degree detecting means configured to detect the blurred degree of said image based on analysis results by said analyzing means.

5. The image processing apparatus according to claim 1, said edge point extracting means classify the type of said image based on predetermined classifying parameters, and set said edge reference value based on of the dynamic range and type of said image.

6. The image processing apparatus according to claim 5, wherein said classifying parameters include at least one of the size of said image and the shot scene of said image.

7. The image processing apparatus according to claim 1, wherein said edge intensity detecting means detect the intensity of an edge of said image based on a difference value of the pixel values of pixels within a block.

8. An image processing method for an image processing apparatus configured to detect the blurred degree of an image, comprising the steps of:
detecting the edge intensity of said image in increments of blocks having a predetermined size;
setting an edge reference value used for extraction of an edge point that is a pixel used for detection of the blurred degree of said image based on a dynamic range that is difference between the maximum value and the minimum value of said edge intensities and
extracting a pixel as said edge point with said edge intensity being equal to or greater than said edge reference value, and also the pixel value of a pixel within a block being included in an edge block that is a block within a predetermined range.

9. A program causing a computer to execute processing comprising the steps of:
detecting the edge intensity of said image in increments of blocks having a predetermined size;
setting an edge reference value used for extraction of an edge point that is a pixel used for detection of the blurred degree of said image based on a dynamic range that is difference between the maximum value and the minimum value of said edge intensities; and
extracting a pixel as said edge point with said edge intensity being equal to or greater than said edge reference value, and also the pixel value of a pixel within a block being included in an edge block that is a block within a predetermined range.

10. A learning apparatus comprising:
image processing means configured to detect the edge intensity of an image in increments of blocks having a predetermined size, classify the type of said image based on a dynamic range that is difference between the maximum value and the minimum value of said edge intensities, extract a pixel included in an edge block that is a block of which said edge intensity is equal to or greater than an edge reference value that is a first threshold as an edge point, and in the case that the extracted amount of said edge point is equal to or greater than an extracted reference value that is a second threshold, analyze whether or not blur occurs at said edge point to determine whether or not said image blurs; and
parameter extracting means configured to extract a combination of said edge reference value and said extracted reference value;
wherein said image processing means use each of a plurality of combinations of said edge reference value and said extracted reference value to classify, regarding a plurality of tutor images, the types of said tutor images, and also determine whether or not said tutor images blur;
and wherein said parameter extracting means extract a combination of said edge reference value and said extracted reference value for each type of said image at which the determination precision regarding whether or not said tutor images by said image processing means blur becomes the highest.

11. The learning apparatus according to claim 10, wherein said image processing means use each of a plurality of combinations of dynamic range determining values for classifying the type of said image based on said edge reference value, said extracted reference value, and the dynamic range of said image to classify, regarding a plurality of tutor images, the types of said tutor images based on said dynamic range determining values, and also determine whether or not said tutor images blur;
and wherein said parameter extracting means extract a combination of said edge reference value, said extracted reference value, and said dynamic range determining value for each type of said image at which the determination precision regarding whether or not said tutor images by said image processing means blur becomes the highest.

12. A learning method for a learning apparatus configured to learn a parameter used for detection of the blurred degree of an image, comprising the steps of:
using each of a plurality of combinations of an edge reference value that is a first threshold, and an extracted reference value that is a second threshold to detect, regarding a plurality of tutor images, the edge intensities of said tutor images in increments of blocks having a predetermined size, classifying the types of said tutor images based on a dynamic range that is difference between the maximum value and the minimum value of said edge intensities, extracting a pixel included in an edge block that is a block of which the edge intensity is equal to or greater than said edge reference value as an edge point, and in the case that the extracted amount of said edge point is equal to or greater than said extracted reference value, analyzing whether or not blur occurs at said edge point to determine whether or not said tutor images blur; and
extracting a combination of said edge reference value and said extracted reference value for each type of said image at which determination precision regarding whether or not said tutor images blur becomes the highest.

13. A program causing a computer to execute processing comprising the steps of:
using each of a plurality of combinations of an edge reference value that is a first threshold, and an extracted reference value that is a second threshold to detect, regarding a plurality of tutor images, the edge intensities of said tutor images in increments of blocks having a predetermined size, classifying the types of said tutor images based on a dynamic range that is difference between the maximum value and the minimum value of said edge intensities, extracting a pixel included in an edge block that is a block of which the edge intensity is equal to or greater than said edge reference value as an edge point, and in the case that the extracted amount of said edge point is equal to or greater than said extracted reference value, analyzing whether or not blur occurs at said edge point to determine whether or not said tutor images blur; and
extracting a combination of said edge reference value and said extracted reference value for each type of said image at which determination precision regarding whether or not said tutor images blur becomes the highest.

14. An image processing apparatus comprising:
an edge intensity detecting unit configured to detect the edge intensity of an image in increments of blocks having a predetermined size;
a parameter setting unit configured to set an edge reference value used for extraction of an edge point that is a pixel used for detection of the blurred degree of said image based on a dynamic range that is difference between the maximum value and the minimum value of said edge intensities; and
an edge point extracting unit configured to extract a pixel as said edge point with said edge intensity being equal to or greater than said edge reference value, and also the pixel value of a pixel within a block being included in an edge block that is a block within a predetermined range.

15. A learning apparatus comprising:
an image processing unit configured to detect the edge intensity of an image in increments of blocks having a predetermined size, classify the type of said image based on a dynamic range that is difference between the maximum value and the minimum value of said edge intensities, extract a pixel included in an edge block that is a block of which said edge intensity is equal to or greater than an edge reference value that is a first threshold as an edge point, and in the case that the extracted amount of said edge point is equal to or greater than an extracted reference value that is a second threshold, analyze whether or not blur occurs at said edge point to determine whether or not said image blurs; and
a parameter extracting unit configured to extract a combination of said edge reference value and said extracted reference value;
wherein said image processing unit uses each of a plurality of combinations of said edge reference value and said extracted reference value to classify, regarding a plurality of tutor images, the types of said tutor images, and also determines whether or not said tutor images blur;
and wherein said parameter extracting unit extracts a combination of said edge reference value and said extracted reference value for each type of said image at which the determination precision regarding whether or not said tutor images from said image processing unit blur becomes the highest.
